(19) United States
(12) Patent Application Publication
(10) Pub. No.: US 2023/0192063 A1
(43) Pub. Date: Jun. 22, 2023

(54) INTEGRATED POWER SYSTEM AND METHOD FOR ENERGY MANAGEMENT FOR ELECTRIC VEHICLE

(71) Applicant: SUSTAINABLE ENERGY TECHNOLOGIES, INC., WILMINGTON, DE (US)

(72) Inventor: John Cronin, WILMINGTON, DE (US)

(21) Appl. No.: 18/075,338

(22) Filed: Dec. 5, 2022

Related U.S. Application Data
(60) Provisional application No. 63/285,879, filed on Dec. 3, 2021.

(51) Int. Cl. B60W 10/26; H02J 7/34; B60L 58/10; B60L 50/40

(52) U.S. Cl. CPC B60W 10/26; H02J 7/345; B60L 58/10; B60L 50/40; B60W 2510/242

(57) ABSTRACT

The present invention discloses an integrated power system and method for energy management for an electric vehicle. The system comprises a plurality of supercapacitor power packs coupled together in series and/or in parallel. The supercapacitor power packs may be integrated with an electric motor. A charge management database is configured to store data related to the charging capacity, energy requirements related to the supercapacitor power packs, and the charge cycle of each of the supercapacitor power packs with respect to consumption. A processor and a memory are coupled to the charge management database to retrieve the performance of the supercapacitor power packs. The memory comprises a plurality of modules to perform charging and/or discharging of the supercapacitor power packs. Further, a display interface displays a status of charging and/or discharging of the electric vehicle based on charge on the supercapacitor power packs.

### CROSS-REFERENCE TO RELATED APPLICATIONS

This application claims the benefit of U.S. Provisional Application No. 63/285,879, filed Dec. 3, 2021, for “INTEGRATED POWER SYSTEM AND METHOD FOR ENERGY MANAGEMENT FOR ELECTRIC VEHICLE,” the disclosure of which is incorporated herein by reference in its entirety.

### FIELD OF THE DISCLOSURE

The present disclosure is generally related to energy management techniques used in electrical vehicles and particularly relates to an integrated power system and a method for energy management for an electric vehicle.

### BACKGROUND

The subject matter discussed in the background section should not be assumed to be prior art merely due to its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The growth of electric vehicles (EVs) has evolved exponentially in recent years, and the need for managing energy in a battery of EVs has greatly increased over the recent years. The EVs, also referred to as battery EVs, use a battery pack to store electrical energy that powers a motor of an electric vehicle. Further, electric vehicle batteries are charged by plugging the vehicle into an electric power source. This electric power source is an external power source or a power charging station. In recent years, there has been a huge increase in the use of electric propulsion in road transport applications, through internal combustion engine hybrid, battery-electric, and fuel cell vehicles, with spark-ignition engine hybrids being the most common. This has opened up an opportunity for regenerative braking, whereby the kinetic energy of a vehicle is converted and stored into electrical energy during braking and recycled to reduce fuel consumption in diesel and fuel cell vehicles and extend the range in battery electric vehicles. In order to make use of this source of power, it is necessary to have some form of energy storage, generally in the batteries and supercapacitors. Batteries are the most popular choice due to the widespread use of batteries in hybrid and electric vehicles.

Another technology involves the use of a power module for a plug-in hybrid electric vehicle which includes an integrated converter having a rectifier changing Alternating Current (AC) to DC, a DC/DC converter changing from a first voltage to a second voltage, and a battery storing electrical energy. The integrated converter operates in three modes which are AC plug-in charging mode, boost mode supplying power from the battery to the electrical bus, and buck mode supplying power from the electrical bus to the battery. The integrated converter utilizes the same single inductor during each of the three operating modes. A controller is provided which includes a first communication connection for receiving signals from the internal combustion engine and a second communication connection for receiving and/or sending signals with respect to a motor-generator. The controller may further include a decision circuit to activate the motor-generator for transferring electrical energy between the battery and mechanical energy from a driveshaft. The controller exclusively sends signals to the motor-generator, in other words, the controller does not send signals to the internal combustion engine, for instance, facilitating and/or simplifying installation of a conversion kit in and/or on the vehicle. Though the transfer of electrical energy is initiated using the integrated converter operating in boost mode, however in order to maintain a level of power in the converter for energy management in the battery, an external electric source or a power source will be required which can increase costs and hence not reliable in case of power transfer from battery to any other component if required. Moreover, the electrical energy from the battery which is then used for commercial or industrial purposes is normally lost, especially in case of unrealized power transfer.

Therefore, there is a need for an efficient, convenient, and economical power system for an electric vehicle to effectively enable management of the energy in the battery pack of the electric vehicle.

### SUMMARY OF THE DISCLOSURE

In one aspect, an integrated power system for energy management of an electric vehicle including an electric motor comprises: a plurality of supercapacitor power packs coupled together in series and/or in parallel and integrated with the electric motor; a processor coupled to the plurality of supercapacitor power packs to perform charging and/or discharging of each of the plurality of supercapacitor power packs based, at least in part, on a power capacity of the plurality of supercapacitor power packs and at least one additional factor; a base module communicatively coupled to the processor, wherein the base module comprises a plurality of sub-modules to perform charging and/or discharging of the plurality of supercapacitor power packs according to instructions received from the processor; and a display interface integrated within the system and coupled to the processor and configured to continuously display a status of charging and/or discharging of a battery pack of the electric vehicle based on charge on the supercapacitor power packs.

In various embodiments, the at least one additional factor may include a speed of the electric motor, a relative complexity of a shape of one or more supercapacitors, historical data (such as historical data obtained through machine learning) regarding operation of the electric motor, a prediction of use of the electric motor (provided, for example, via machine learning), a temperature outside of the electric vehicle, a geolocation of the electric vehicle indicating one or more terrain changes along an actual or predicted route, and/or real-time machine learning of historical charging verses electric motor use.

In some embodiments, at least one sub-module is configured to charge and/or discharge one or more of the plurality of supercapacitor power packs. In some embodiments, at least one sub-module is configured to charge and/or discharge only one sub-unit of a supercapacitor. In some embodiments, at least one sub-module is configured to charge and/or discharge multiple sub-units of one or more supercapacitors. In some embodiments, at least one sub-module is configured to charge and/or discharge a group of sub-units of one or more supercapacitors. In some embodiments, at least one sub-module is configured to charge one or more supercapacitors based on their location relative to the electric motor.

The system may further include thermal control hardware in association with the supercapacitor power packs to regulate supercapacitor temperature. The thermal control hardware may include systems for both cooling and heating of supercapacitors. In some embodiments, the thermal control hardware comprises a low-temperature power source for warming one or more supercapacitors to a suitable operating temperature. In some embodiments, the base module further comprises a thermal management module operably associated with the thermal control hardware to control the temperature of supercapacitors during at least one of starting and operating the electric vehicle.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one. In some examples, an element shown as an internal component of one element may be implemented as an external component in another and vice versa. Furthermore, elements may not be drawn to scale. Non-limiting and non-exhaustive descriptions are described regarding the following drawings. The components in the figures are not necessarily to scale, emphasis instead being placed upon illustrating principles.

FIG. 1A is a block diagram of an energy storage unit (ESU) and an energy control system (ECS), according to an embodiment.

FIG. 1B is a is block diagram of an integrated power system for an electric vehicle, according to an embodiment.

FIG. 2 illustrates a charge management database, according to an embodiment;

FIGS. 3A-3B illustrate a flowchart showing a method performed by a base module, according to an embodiment;

FIG. 4 illustrates a flowchart showing a method performed by an energy management module, according to an embodiment;

FIG. 5 illustrates a flowchart showing a method performed by an AI/ML module, according to an embodiment;

FIG. 6 illustrates a flowchart showing a method performed by a charge detection module, according to an embodiment;

FIG. 7 illustrates a flowchart showing a method performed by a motor control module, according to an embodiment;

FIG. 8 illustrates a flowchart showing a method performed by a supercapacitor module, according to an embodiment; and

FIG. 9 illustrates a flowchart showing a method performed by a communication module, according to an embodiment.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the,” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. However, embodiments of the claims may be embodied in many different forms and should not be construed as limited to the embodiments set forth herein. The examples set forth herein are non-limiting examples and are merely examples among other possible examples.

### Energy Storage Unit (ESU)

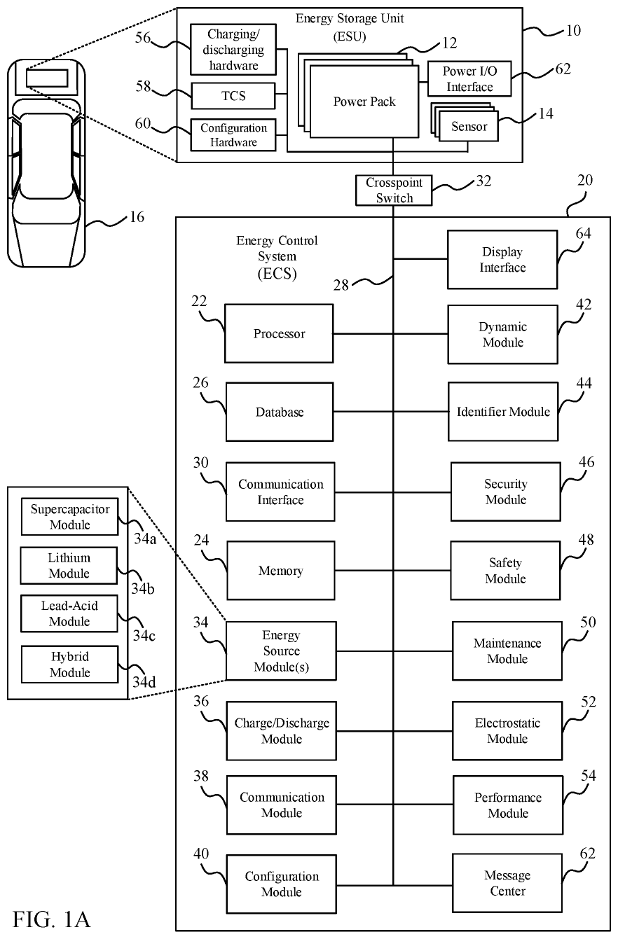

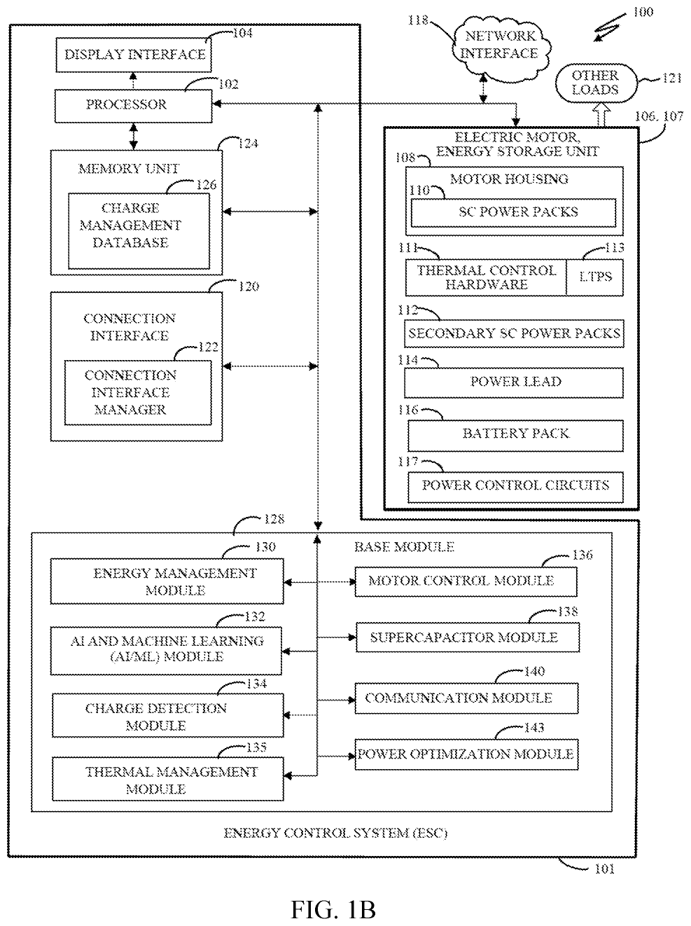

FIG. 1A illustrates an energy storage unit (ESU) 10 for supercapacitors according to one embodiment. As used herein, a supercapacitor may also be an ultracapacitor, which is an electrical component capable of holding hundreds of times more electrical charge than a standard capacitor. This characteristic makes ultracapacitors useful in devices that require relatively little current and low voltage. In some situations, an ultracapacitor can take the place of a rechargeable low-voltage electrochemical battery.

Ultracapacitors or supercapacitors typically have high power density meaning they can charge up quickly, but they also discharge quickly as well. The load curve of a chemical battery typically shows a high energy density, meaning that, on discharge, it is very stable (i.e., the voltage doesn't change much over time for a given load) for long periods of time. This means that the chemical battery (lead-acid or lithium-ion, etc.) has a high energy density but low power density. In other words, they charge slowly. Ultracapacitors or supercapacitors have been developed recently that have both a high power density (charge fast) and a high energy density (discharge slowly). Ideally, an ultracapacitor or supercapacitor has both a high power density and a high energy density, with a load discharge curve that resembles or comes close to a load discharge curve of a chemical battery. Hereafter, the term supercapacitor will be used generically to mean all forms of supercapacitors, but ideally one that has both high power density as well as high energy density.

The illustrated ESU 10 is a device that can store and deliver charge. It may comprise one or more power packs 12 which, in turn, may comprise supercapacitors. The ESU 10 may also comprise batteries, hybrid systems, fuel cells, etc. Capacitance provided in the components of the ESU 10 may be in the form of electrostatic capacitance, pseudocapacitance, electrolytic capacitance, electronic double layer capacitance, and electrochemical capacitance, and a combination thereof, such as both electrostatic double-layer capacitance and electrochemical pseudocapacitance, as may occur in supercapacitors. The ESU 10 may be associated with or comprise control hardware and software with suitable sensors 14, as needed, in order for an energy control system (ECS) 20 to manage any of the following: temperature control, discharging of the ESU 10 (whether collectively or of any of its components), charging of the ESU 10 (whether collectively or of any of its individual components), maintenance, interaction with batteries, battery emulation, communication with other devices, including devices that are directly connected, adjacent, or remote such as by wireless communication, etc. In some aspects, the ESU 10 may be portable and may be provided in a casing that also contains at least some components of the energy control system (ECS) 20 as well as various features, such as communication systems, a display interface, etc. The ESU 10 may be housed within, and provide power to, a device 16, such as an electric vehicle (EV).

### Energy Control System (ECS)

The ECS 20 is the combination of hardware and software that manages various aspects of the ESU 10 including the energy delivered by it to one or more devices. The ECS 20 regulates the ESU 10 to control discharging, charging, and other features as desired such as temperature, safety, efficiency, etc. The ESU 10 may be adapted to give the ECS 20 individual control over each power pack or optionally over each supercapacitor or grouped supercapacitor unit in order to efficiently tap the available power of individual supercapacitors and to properly charge individual supercapacitors rather than merely providing a single level of charge for the ESU 10 as a whole that may be too little or too much for individual supercapacitors or their power packs.

The ECS 20 may comprise or be operatively associated with a processor 22, a memory 24 comprising code for the controller, a database 26, a bus 28, and one or more communication interfaces 30, such as a wireless interface, for interacting with other units or otherwise providing information, information requests, or commands. The ECS 20 may interact with individual power packs 12 or supercapacitors through a crosspoint switch 32 or other matrix systems. Further, the ECS 20 may obtain information from individual power packs 12 or their supercapacitors through similar switching mechanisms or direct wiring in which, for example, one or more of a voltage detection circuit, an amperage detection circuit, a temperature sensor, and other sensors or devices may be used to provide details on the level of charge and performance of the individual power pack 12 or supercapacitor.

The ECS 20 may comprise one or more energy source modules 34, a charge/discharge module 36, a communication module 38, a configuration module 40, a dynamic module 42, an identifier module 44, a security module 46, a safety module 48, a maintenance module 50, an electrostatic module 52 and a performance module 54, etc. The ECS 20 may comprise one or more modules that can be executed or governed by the processor 22 according to code stored in a memory 24, such as a chip, a hard drive, a cloud-based source or other computer readable medium.

The ECS 20 may therefore manage any or all of the following: temperature control, discharging of the ESU 10 (whether collectively or of any of its components), charging of the ESU 10 (whether collectively or of any of its individual components), maintenance, interaction with batteries or battery emulation, and communication with other devices, including devices that are directly connected, adjacent, or remote, such as by wireless communication.

The ECS 20 may comprise one or more energy source modules 34 that govern specific types of energy storage devices, such as a supercapacitor module 34a for governing supercapacitors, a lithium module 34b for governing lithium batteries, a lead-acid module 34c for governing lead-acid batteries, and a hybrid module 34d for governing the combined cooperative use of a supercapacitor and a battery. Each of the energy storage modules 34 may comprise software encoding algorithms for control such as for discharge or charging or managing individual energy sources, and may comprise or be operationally associated with hardware for redistributing charge among the energy sources to improve efficiency of the ESU 10, for monitoring charge via charge measurement systems such as circuits for determining the charge state of the respective energy sources, etc., and may comprise or be operationally associated with devices for receiving and sending information to and from the ECS 20 or its other modules, etc. The energy source modules 34 may also cooperate with the charge/discharge module 36 responsible for guiding the charging of the overall ESU 10 to ensure a properly balanced charge, as well as the efficient discharging of the ESU 10 during use which may also seek to provide proper balance in the discharging of the energy sources.

The dynamic module 42 may be used for managing changing requirements in the power supplied. In some aspects, the dynamic module 42 comprises anticipatory algorithms which seek to predict upcoming changes in power demand and to adjust the state of the ECS 20 in order to be ready to more effectively handle the change. For example, in one case, the ECS 20 may communicate with a GPS and/or terrain map (not shown) for the route being taken by the electric vehicle and recognize that a steep hill will soon be encountered. The ECS 20 may anticipate the need to increase torque and thus deliver electrical power from the ESU 10, and thus activate additional power packs 12 if only some are in use or otherwise increase the draw from the power packs 12 in order to handle the change in slope efficiently to achieve desired objectives such as maintaining speed, reducing the need to shift gears on a hill, or reducing the risk of stalling or other problems.

The communication module 38 and an associated configuration system may be used to properly configure the ECS 20 to communicate not only with the interface or other aspects of a vehicle, but also to communicate with central systems or other vehicles, when desired. In such cases, a fleet of vehicles may be effectively monitored and managed to improve energy efficiency and track performance of vehicles and their ESUs 10, thereby providing information that may assist with maintenance protocols, for example. Such communication may occur wirelessly or through the cloud via the communication interface 30, and may share information with various central databases, or access information from databases to assist with the operation of the vehicle and the optimization of the ESU 10, for which historical data may be available in a database.

Databases 26 of use with the ECS 20 include databases 26 on the charge and discharge behavior of the energy sources in the ESU 10 in order to optimize both charging and discharging in use based on known characteristics, databases 26 of topographical and other information for a route to be taken by the electric vehicle or an operation to be performed by another device employing the ESU 10, wherein the database 26 provides guidance on what power demands are to be expected in advance in order to support anticipatory power management wherein the status of energy sources and the available charge is prepared in time to deliver the needed power proactively. Charging databases 26 may also be of use in describing the characteristics of an external power source that will be used to charge the ESU 10. Knowledge of the characteristics of the external charge can be used to prepare for impedance matching or other measures needed to handle a new input source to charge the ESU 10, and with that data the external power can be received with reduced losses and reduced risk of damaging elements in the ESU 10 by overcharge, excessive ripple in the current, etc.

Beyond relying on static information in databases 26, in some aspects, the processor 22 is adapted to perform machine learning and to constantly learn from situations faced. In related aspects, the processor and the associated software form a “smart” controller based on machine learning or artificial intelligence adapted to handle a wide range of input and a wide range of operational demands.

In one embodiment, the ESU 10 is governed or controlled by the ECS 20, which is adapted to optimize at least one of charging, discharging, temperature management, safety, security, maintenance, and anticipatory power delivery. The ECS 20 may communicate with a display interface 64, to assist in control or monitoring of the ESU 10 and also may comprise a processor and a memory. The ECS 20 may interact with the hardware of the ESU 10, such as charging and discharging hardware 56, a temperature control system (TCS) 58, and configuration hardware 60, which not only provide data to the ECS 20 but also respond to directions from the ECS 20 for the management of the ESU 10.

### ESU Hardware

### Charging and Discharging Hardware

The charging and discharging hardware 56 may include the wiring, switches, charge detection circuits, current detection circuits, and other devices for proper control of charge applied to the power packs 12 or to the batteries or other ESUs 10, as well as temperature-control devices, such as active cooling equipment and other safety devices. Active cooling devices (not shown) may include fans, circulating heat transfer fluids that pass through tubing or in some cases surround or immerse the power pack, and thermoelectric cooling, such as Peltier effect coolers, etc.

In order to charge and discharge an individual power pack 12 to optimize the overall efficiency of the ESU 10, methods and devices are provided to select one or more of many power packs 12 from what may be a three-dimensional or two-dimensional array of connectors to the individual units. Any suitable methods and devices may be used for such operations, including the use of crosspoint switches 32 or other matrix switching tools. Crosspoint switches 32 and matrix switches are means of selectively connecting specific lines among many possibilities, such as an array of X lines (X1, X2, X3, etc.) and an array of Y lines (Y1, Y2, Y3, etc.) that may respectively have access to the negative or positive electrodes or terminals of the individual units among the power packs as well as the batteries or other energy storage units. Single-Pole Single-Throw (SPST) relays, for example, may be used. By applying charge to individual supercapacitors within power packs or to individual power packs within the ESU 10, charge can be applied directly to where it is needed and supercapacitor or power pack 12 can be charged to an optimum level independently of other power packs or supercapacitors. See “Understanding Tree and Crosspoint Matrix Architectures,” Pickering Test, https://www.pickeringtest.com/en-us/kb/hardware-topics/switching-architectures/understanding-tree-and-crosspoint-matrix-architectures, accessed Oct. 28, 2021.

Examples of crosspoint switches 32 and related components that may be adapted for one or more aspects of the disclosure herein, particularly the charging of supercapacitors or related power packs, are described in: “Digital Crosspoint Switches,” MicroSemi Corp. (Aliso Viejo, Calif.), https://www.microsemi.com/product-directory/signal-integrity/3579-digital-crosspoint-switches; “Micrel™ 2.5V/3.3V 3.0 GHz Dual 2×2 CML Crosspoint Switch w/Internal Termination, SuperLite™ SY55858U,” 2005, http ://ww1.microchip.com/downloads/en/DeviceDoc/sy55858u. pdf; “Details, datasheet, quote on part number: BQ24640RVAR,” part of the BQ24640 family for “High Efficiency Synchronous Switch-Mode Battery Charge Controller for Supercapacitors,” Texas Instruments (Dallas, Tex.), https://www.digchip.com/datasheets/3258066-bq24640rvar.html; “8×8 Analog Crosspoint Switches Analog & Digital Crosspoint ICs,” Mouser Electronics (Mansfield, Tex.), https://www.mouser.com/c/semiconductors/communication-networking-ics/analog-digital-crosspoint-ics/; “200-MHz 16×16 Video Crosspoint Switch IC,” Analogue Dialogue, April 1997, https://www.analog.com/en/analog-dialogue/articles/200-mhz-16×16-video-crosspoint-switch-ic.html; “Crossbar Switch,” and Wikipedia, https://en.wikipedia.org/wiki/Crossbar_switch, accessed Oct. 28, 2021.

### Configuration Hardware

The configuration hardware 60 may include switches, wiring, and other devices to transform the electrical configuration of the power packs 12 between series and parallel configurations, such that a matrix of power packs may be configured to be in series, in parallel, or in some combination thereof. For example, as 12×6 array of power packs 12 may include four groups in series, with each group having 3×6 power packs in parallel. The configuration can be modified by a command from the configuration module 40, which then causes the configuration hardware 60 to make the change at an appropriate time (e.g., when the device is not in use).

### Sensors

The sensors 14 may include thermocouples, thermistors, or other devices associated with temperature measurement such as IR cameras, etc., as well as strain gauges, pressure gauges, load cells, accelerometers, inclinometers, velocimeters, chemical sensors, photoelectric cells, cameras, etc., that can measure the status of the power packs 12 or batteries or other ESUs 10, or other characteristics of the ESU 10 or the device, as described more fully hereafter. The sensors 14 may comprise sensors physically contained in or on the ESU 10, or also comprise sensors mounted elsewhere such as engine gauges that are in electronic communication with the ESU 10 or its associated ECS 20.

### Batteries and Other Energy Sources

The ESU 10 may be capable of charging, or supplementing the power provided from the batteries or other ESUs 10 including chemical and nonchemical batteries, such as but not limited to lithium batteries (including those with titanate, cobalt oxide, iron phosphate, iron disulfide, carbon monofluoride, manganese dioxide or oxide, nickel cobalt aluminum oxides, nickel manganese cobalt oxide, etc.), lead-acid batteries, alkaline or rechargeable alkaline batteries, nickel-cadmium batteries, nickel-zinc batteries, nickel-iron batteries, nickel-hydrogen batteries, nickel-metal-hydride batteries, zinc-carbon batteries, mercury cell batteries, silver oxide batteries, sodium-sulfur batteries, redox-flow batteries, supercapacitor batteries, and combinations or hybrids thereof.

### Power Input/Output Interface

The ESU 10 also comprises or is associated with a power input/output interface 62 that can receive charge from a device (or a plurality of devices in some cases) such as the grid or from regenerative power sources in an electric vehicle (not shown), and can deliver charge to the device 16. The power input/output interface 62 may comprise one or more inverters, charge converters, or other circuits and devices to convert the current to the proper type (e.g., AC or DC) and voltage or amperage for either supplying power to, or receiving power from, the device to which it is connected. Bidirectional DC-DC converters may also be applied, as described in the case of electric vehicles in M. B. Camara et al., “Polynomial Control Method of DC/DC Converters for DC-Bus Voltage and Currents Management—Battery and Supercapacitors,” IEEE Transactions on Power Electronics, vol. 27, no. 3 (March 2012): 1455-67, DOI: 10.1109/TPEL.2011.2164581.

The power input/output interface 62 may be adapted to receive power from a wide range of power sources, such as via two-phase or three-phase power, DC power, etc., and may receive or provide power by wires or inductively or any other useful means. Converters, transformers, rectifiers, and the like may be employed as needed. The power received may be relatively steady from the grid or other sources at voltages such as 110V, 120V, 220V, 240V, etc., or may be from highly variable sources such as from solar or wind power where amperage or voltage may vary. DC sources may be, by way of example, from 1V to 1000V or higher, such as from 4V to 200V, 5V to 120V, 6V to 100V, 2V to 50V, 3V to 24V, or nominal voltages of about 4, 6, 12, 18, 24, 30, or 48 V. Similar ranges may apply to AC sources, but also including from 60V to 300V, from 90V to 250V, from 100V to 240 V, etc., operating at any useful frequency such as 50 Hz, 60 Hz, 100 Hz, etc.

Power received or delivered may be modulated, converted, smoothed, rectified, or transformed in any useful way to better meet the needs of the application and the requirements of the device and/or the ESU 10. The use of impedance matchers, for example, can help optimize the transfer of power from a photovoltaic array to a DC or AC source such as a powered device or the grid. For example, pulse-width modulation (PWM), sometimes called pulse-duration modulation (PDM), may be used to reduce the average power delivered by an electrical signal as it is effectively chopped into discrete parts. Likewise, maximum power point tracking (MPPT) may be employed to keep the load at the right level for the most efficient transfer of power.

The power input/out interface 62 may have a plurality of receptacles for receiving power and a plurality of outlets for providing power to one or more devices. Conventional AC outlets may include any known outlet such as those common in North America, various parts of Europe, China, Hong Kong, etc.

### ECS Components and Modules

### Processor

The processor 22 may comprise one or more microchips or other systems for executing electronic instructions and can provide instructions to regulate the charging and discharging hardware 56 and, when applicable, the configuration hardware 60 or other aspects of the ESU 10 and/or other aspects of the ECS 20 and its interactions with the device, the cloud, etc. In some cases a plurality of processors 22 may collaborate, including processors 22 installed with the ESU 10 and processors installed in a vehicle or other device.

### Memory

The memory 24 may comprise coding for operation of one or more of the ECS 20 modules and their interactions with each other or other components. It may also comprise information, such as databases pertaining to any aspect of the operation of the ECS 20. Additional databases 26 may be stored in a storage device, such as a hard disk drive, or may be available via the cloud. Such databases 26 can include a charging database that describes the charging and/or discharging characteristics of a plurality or all of the energy sources (the power packs and the batteries or other energy storage units), for guiding charging and discharging operations. Such data may also be included with energy-source-specific data provided by or accessed by the energy source modules 34.

The memory 24 may be in one or more locations or components, such as a memory chip, a hard drive, a cloud-based source or other computer readable medium, and may be in any useful form such as flash memory, EPROM, EEPROM, PROM, MROM, etc., or combinations thereof and in consolidated (centralized) or distributed forms. The memory 24 may in whole or in part be read-only memory (ROM) or random-access memory (RAM), including static RAM (SRAM), dynamic RAM (DRAM), synchronous dynamic RAM (SDRAM), and magneto-resistive RAM (MRAM), etc.

The ECS 20 may communicate with other entities via the cloud or other means, and such communication may involve information received from and/or provided to one or more databases 26 and a message center 62. The message center 62 can be used to provide alerts to an administrator responsible for the ESU 10 and/or the electric vehicle or other device. For example, an entity may own a fleet of electric vehicles using ESUs 10, and may wish to receive notifications regarding usage, performance, maintenance issues, and so forth. The message center 62 may also participate in authenticating the ESU 10 or verifying its authorization for use in the electric vehicle or other device via interaction with the security module 46.

### Energy Source Modules

The energy source modules 34 may comprise specific modules designed for the operation of a specific type of energy source such as supercapacitor module 34a, a lithium battery module 34b, a lead-acid battery module 34c, a hybrid module 34d, or other modules. Such modules may be associated with a database 26 of performance characteristics (e.g., charge and discharge curves, safety restrictions regarding overcharge, temperature, etc.) that may provide information for use by the safety module 48 and the charge/discharge module 36, which is used to optimize the way in which each unit within the power packs 12 or batteries or other ESUs 10 is used both in terms of charging and delivering charge. The charge/discharge module 36 seeks to provide useful work from as much of the charge as possible in the individual power packs 12 while ensuring that individual power packs 12 are fully charged but not damaged by overcharging. The charge/discharge module 36 can assist in directing the charging/discharging hardware 56, cooperating with the energy source modules 34. In one aspect, the ESU 10 thus may provide real-time charging and discharging of the plurality of power packs 12 while the electric vehicle is continuously accelerating and decelerating along a path.

### Charge/Discharge Module

The charge/discharge module 36 is used to optimize the way in which each unit within the power packs 12 or batteries or other ESUs 10 is used both in terms of charging and delivering charge. The charge/discharge module 36 seeks to provide useful work from as much of the charge as possible in the individual power packs 12 while ensuring during charging that individual power packs 12 are fully charged but not damaged by overcharging. The charge/discharge module 36 can assist in directing the charging/discharging hardware 56, cooperating with the energy source modules 34. In one aspect, the ESU 10 thus may provide real-time charging and discharging of the plurality of power packs 12 while the electric vehicle is continuously accelerating and decelerating along a path.

The charge/discharge module 36 may be configured to charge or discharge each of the plurality of power packs 12 up to a threshold limit. The charge/discharge module 36 may be communicatively coupled to the performance module 54, the energy source modules 34, and the identifier module 44, among others, and may communicate with the charging/discharging hardware 56 of the ESU 10. For example, in one aspect, the threshold limit may be more than 90 percent capacity of each of the plurality of power packs 12.

### Dynamic Module

The dynamic module 42 assists in coping with changes in operation including acceleration, deceleration, stops, changes in slopes (uphill or downhill), changes in traction or properties of the road or ground that affect traction and performance, etc., by optimizing the delivery of power or the charging that is taking place for individual power packs 12 or batteries or other ESUs 10. In addition to guiding the degree of power provided by or to individual power packs 12 based on current use of the device 16 and the individual state of the power packs 12, in some aspects the dynamic module 42 provides anticipatory management of the ESU 10 by proactively adjusting the charging or discharging states of the power packs 12 such that added power is available as the need arises or slightly in advance (depending on time constants for the ESU 10 and its components, anticipatory changes in status may only be needed for a few seconds (e.g., five seconds or less or two seconds or less) or perhaps only for 1 second or less such as for 0.5 seconds or less, but longer times of preparatory changes may be needed in other cases, such as from 3 seconds to 10 seconds, to ensure that adequate power is available when needed but that power is not wasted by changing the power delivery state prematurely. This anticipatory control can involve not only increasing the current or voltage being delivered, but also increasing the cooling provided by the cooling hardware of the charging and discharging hardware 56 in cooperation with safety module 48 and when suitable with the charge/discharge module 36.

The dynamic module 42 may be communicatively coupled to the charge/discharge module 36. The dynamic module 42 may be configured to determine the charging and discharging status of the plurality of power packs 12 and batteries or other ESUs 10 in real-time. For example, in one aspect, the dynamic module 42 may help govern bidirectional charge/discharge in real-time in which the electric charge may flow from the ESU 10 into the plurality of power packs 12 and/or batteries or other ESUs 10 or vice versa.

### Configuration Module

The ECS 20 may comprise a configuration module 40 configured to determine any change in configuration of charged power packs 12 from the charging module. For example, in one aspect, the configuration module 40 may be provided to change the configuration of the power packs 12, such as from series to parallel or vice versa. This may occur via communication with the charging/discharging hardware 56 of the ESU 10.

### Identifier Module

The identifier module 44, described in more detail hereafter, identifies the charging or discharging requirement for each power pack 12 to assist in best meeting the power supply needs of the device 16. This process may require access to database information about the individual power packs 12 from the energy source modules 34 (e.g., a supercapacitor module 34a) and information about the current state of the individual power packs 12 provided by the sensors 14 and charge and current detections circuits associated with the charging and discharging hardware 56, cooperating with the charge/discharge module 36 and, as needed, with the dynamic module 42 and the safety module 48.

### Safety Module

The sensors 14 may communicate with the safety module 48 to determine if the temperature of the power packs 12 and/or individual components therein show signs of excessive local or system temperature that might harm the components. In such cases, the safety module 48 interacts with the processor 22 and other features (e.g., data stored in the databases 26 of the cloud or in memory 24 pertaining to safe temperature characteristics for the ESU 10) to cause a change in operation such as decreasing the charging or discharging underway with the portions of the power packs 12 or other units facing excessive temperature. The safety module 48 may also regulate cooling systems that are part of the charging and discharging hardware 56 in order to proactively increase cooling of the power packs 12 or batteries or other ESUs 10, such that increasing the load on them does not lead to harmful temperature increase.

Thus, the safety module 48 may also interact with the dynamic module 42 in responding to forecasts of system demands in the near future for anticipatory control of the ESU 10 for optimized power delivery. In the interaction with the dynamic module 42, the safety module 48 may determine that an upcoming episode of high system demand from the device 16, such as imminent climbing of a hill, may impose excessive demands on a power pack already operating at elevated temperature, and thus make a proactive recommendation to increase cooling on the at-risk power packs 12. Other sensors 14, such as strain gauges, pressure gauges, chemical sensors, etc., may be provided to determine if any of the ESUs 10 in batteries or other ESUs 10 or the power packs 12 are facing pressure buildup from outgassing, decomposition, corrosion, electrical shorts, unwanted chemical reactions such as an incipient runaway reaction, or other system difficulties. In such cases, the safety module 48 may then initiate precautionary or emergency procedures such as a shut down, electrical isolation of the affected components, warnings to a system administrator via the communication module 38 to the message center 62, a request for maintenance to the maintenance module 50.

### Maintenance Module

The maintenance module 50 determines when the ESU 10 requires maintenance, either per a predetermined schedule or when needed due to apparent problems in performance, as may be flagged by the performance module 54, or in issues pertaining to safety as determined by the safety module 48 based on data from sensors 14 or the charging/discharging hardware 56, and in light of information from the energy sources modules 34. The maintenance module 50 may cooperate with the communication module 38 to provide relevant information to the display interface 64 and/or to the message center 62, where an administrator or owner may initiate maintenance action in response to the message provided. The maintenance module 50 may also initiate mitigating actions to be taken such as cooperating with the charge/discharge module 36 to decrease the demand on one or more of the power packs 12 in need of maintenance, and may also cooperate with the configuration module 40 to reconfigure the power packs 12 to reduce the demand in components that may be malfunctioning of near to malfunctioning to reduce harm and risk.

### Performance Module

The performance module 54 continually monitors the results obtained with individual power packs 12 and the batteries or other ESUs 10 and stores information as needed in memory 24 and/or in the databases 26 of the cloud or via messages to the message center 62. The monitoring is done through the use of the sensors 14 and the charging/discharging hardware 56, etc. The tracking of performance attributes of the individual energy sources can guide knowledge about the health of the system, the capabilities of the components, etc., which can guide decisions about charging and discharging in cooperation with the charge/discharge module 36. The performance module 54 compares actual performance, such as power density, charge density, time to charge, thermal behavior, etc., to specifications and can then cooperate with the maintenance module 50 to help determine if maintenance or replacement is needed and alert an administrator via the communication module 38 with a message to the message center 62 about apparent problems in product quality.

### Security Module

The security module 46 helps to reduce the risk of counterfeit products or of theft or misuse of legitimate products associated with the ESU 10, and thus can include one or more methods for authenticating the nature of the ESU 10 and/or authorization to use it with the device 16 in question. Methods of reducing the risk of theft of unauthorized use of an ESU 10 or its respective power packs 12 can include locks integrated with the casing of the ESU 10 that mechanically secure the ESU 10 in the electric vehicle or other device 16, wherein a key, a unique fob, a biometric signal such as a finger print or voice recognition system, or other security-related credentials may be required to enable removal of the ESU 10 or even operation thereof.

In another aspect, the ESU 10 comprises a unique identifier (not shown) that can be tracked, allowing a security system to verify that a given ESU 10 is authorized for use with the device 16, such as an electric vehicle. For example, the casing of the ESU 10 or of one or more power packs 12 therein may have a unique identifier attached such as an RFID tag with a serial number (an active or passive tag), a holographic tag with unique characteristics equivalent to a serial number or password, nanoparticle markings that convey a unique signal, etc. One exemplary security tool that may be adapted for the security of the ESU 10 is a seemingly ordinary bar code or QR code with unique characteristics not visible to the human eye that cannot be readily copied, is the Unisecure™ technology offered by Systech (Princeton, N.J.), a subsidiary of Markem-Image, that essentially allows ordinary QR codes and barcodes to become unique, individual codes by analysis of tiny imperfections in the printing to uniquely and robustly identify every individual products, even if it seems that the same code is printed on each product. The technology is described in part in U.S. Pat. No. 10,380,601, “Method and system for determining whether a mark is genuine,” issued Aug. 13, 2019 to M. L. Soborski; U.S. Pat. No. 9,940,572, “Methods and a computing device for determining whether a mark is genuine,” issued Apr. 10, 2018 to M. L. Soborski; U.S. Pat. No. 10,235,597, “Methods and a computing device for determining whether a mark is genuine,” issued Mar. 19, 2019 to M. Voigt et al.; U.S. Pat. No. 9,519,942, “Methods and a computing device for determining whether a mark is genuine,” issued Dec. 13, 2016 to M. L. Soborski; and U.S. Pat. No. 8,950,662, “Unique identification information from marked features,” issued Feb. 10, 2015 to M. L. Soborski.

Yet another approach relies at least in part in the unique electronic signature of the ESU 10, and/or of one or more individual power packs 12 or of one or more supercapacitor units therein. The principle will be described relative to an individual power pack 12, but may be adapted to an individual supercapacitor or collectively to the ESU 10 as a whole. When a power pack 12 comprising supercapacitors is charged from a low voltage or relatively discharged state, the electronic response to a given applied voltage depends on many parameters, including microscopic details of the electrode structure such as porosity, pore size distribution, and distribution of coating materials, or details of electrolyte properties, supercapacitor geometry, etc., as well as macroscopic properties such as temperature. At a specified temperature or temperature range and under other suitable macroscopic conditions (e.g., low vibration, etc.), the characteristics of the power pack 12 may then be tested using any suitable tool capable of identifying a signature specific to the individual power pack. Such techniques may include impedance spectroscopy, cyclic voltammetry, etc., measured under conditions such as Cyclic Charge Discharge (CCD), galvanostatic charge/discharge, potentiostatic charge/discharge, and impedance measurements. etc. An electronic signature of time effects (characteristic changes in time of voltage or current, for example, is response to an applied load of some kind) may be explored for a specified scenario such as charging a 90% discharged power pack to a state of 50% charge or examining the response to difference applied voltages such as −3V to +4V. Voltammograms may be obtained showing, for example, the response of the power pack to different scan rates. See, for example, “Testing Super-Capacitors, Part 1: CV, EIS, and Leakage Current,” Apr. 16, 2015, https://www.gamry.com/assets/Uploads/Super-capacitors-part-1-rev-2.pdf, and “Testing Electrochemical Capacitors Part 2—Cyclic Charge Discharge and Stacks,” Nov. 14, 2011, https://www.gamry.com/assets/Application-Notes/Testing-Super-Capacitors-Pt2.pdf. Instrumentation for such testing may include a variety of electrical signal analysis tools, including, for example, the Gamry Instruments PWR800 system (Gamry Instruments Inc., Warminster, Pa.). Also see Erik Surewaard et al., “A Comparison of Different Methods for Battery and Supercapacitor Modeling,” SAE Transactions, Journal of Engines, vol. 112, Section 3 (2003): 1851-1859, https://www.jstor.org/stable/44741399. Also see Yuru Ge et al., “How to measure and report the capacity of electrochemical double layers, supercapacitors, and their electrode materials,” Journal of Solid State Electrochemistry, vol. 24 (2020): 3215-3230, https://link.springer.com/article/10.1007/s10008-020-04804-x.

Recognizing that the details of supercapacitor response to a certain load or charge/discharge process may vary gradually over time, especially if the supercapacitor has been exposed to excess voltage or other mechanical or electrical stress, the security module 46 can be adaptive and recognize and accept change within certain limits. Changes observed in the response characteristics can be used to update a security database or performance database for the ESU 10, so that future authentication operations will compare the measured behavior profile of the ESU's power pack in question with the updated profile for authentication purposes and for tracking of performance changes over time. Such information may also be shared with the maintenance module 50 (and may be stored in the database 26), which may trigger a request or requirement for service if there are indications of damage pointing to the need of repair or replacement. When a power pack 12 or supercapacitor therein is replaced due to damage, the response profile of the power pack 12 can then be updated in the security database. When such physical changes cause changes to the measured electronic characteristics that exceed a reasonable threshold, the authorization for use of that ESU 10 may be withdrawn pending further confirmation of authenticity or necessary maintenance.

In another aspect, each ESU 10 and optionally each power pack 12 of the ESU 10 may be associated with a unique identifier registered in a blockchain system, and each “transaction” of the ESU 10, such as each removal from a vehicle, maintenance operations, purchase or change in ownership, and installation into a vehicle or other device, can be recorded and tracked. A code, e.g., Radio Frequency Identification (RFID) signal, or other identifier may be read or scanned for each transaction, such that the blockchain record may then be updated. The blockchain record may comprise an information about the authorization state of the product, such as information on what vehicle or vehicles or products the ESU 10 is authorized for, or an identifier associated with the authorized user may be provided which can be verified or authenticated when the ESU 10 is installed in a new setting or when a transaction occurs. The authorization record may be updated at any time, including when a transaction occurs. Mechanisms may be provided by the vendor to resolve disputes regarding authorization status or other questions.

In some aspects, such as in military or government operation, the ESU 10 may comprise an internal “kill switch” or other inactivation device (not shown) that can be remotely activated by authorities in the event of a crime, unauthorized use, or violation of contract. Alternatively, or in addition, an electric vehicle or other device may be adapted to reject installation of an ESU 10 that is not authorized for use in the vehicle or device 16.

### Communication Module

The communication module 38 can govern communications between the ECS 20 and the outside world, including communications through the cloud, such as making queries and receiving data from various external databases or sending messages to a message center where they may be processed and archived by an administrator, a device owner, the device user, the ESU 10 owner, or automated systems. In some aspects, the communication module 38 may also oversee communication between modules or between the ESU 10 and the ECS 20, and/or work in cooperation with various modules to direct information to and from the display interface 64. Communications within a vehicle or between the ECS 20 or ESU 10 and the device may involve a DC bus 28 or other means such as separate wiring. Any suitable protocol may be used, including UART, LIN (or DC-LIN), CAN, SPI, I2C (including Intel's SMBus), and DMX (e.g., DMX512). In general, communications from the ECS 20 or ESU 10 with a device may be over a DC bus 28 or, if needed, over an AC/DC bus, or by separately wired pathways if desired, or may be wireless. Useful transceivers for communicating over DC lines include, for example, the SIG family and DCB family of transceivers from Yamar Electronics, LTD (Tel Aviv, Israel), and Yamar's DCAN500 device for CAN2.0 A/B protocol messages.

Communication to the cloud may occur via the communication module 38 and may involve a wired or a wireless connection. If wireless, various communication techniques may be employed such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques.

### Electrostatic Module

Assessment of charge in an ESU 10 can be conducted based on measurements made with the charging/discharging hardware 56, in communication with certain modules of the ECS 20. In general, the measurement of charge and processing of the data can be said to be managed by an electrostatic module.

The electrostatic module 52 may be configured to identify the power pack type and the capacity of each power pack connected to the modular multi-type power pack ESU 10. Further, the electrostatic module may be configured to retrieve information related to the type of power packs 12 from the charging database 26. The electrostatic module 52 may determine the capacity of each power pack to be charged and may be configured to determine the capacity of each power pack when connected to the modular multi-type power pack ESU 10.

The electrostatic module may be configured to determine if each power pack charged below the threshold limit. For example, in one aspect, the electrostatic module 52 may check whether each of the plurality of power packs 12 may have capacity below the threshold limit. The electrostatic module 52 may also be configured to send data related to power packs 12 to the ECS 20.

### Various Databases

The ECS 20 may access various databases 26 locally or via an interface to the cloud and store retrieved information in the memory 24 for use to guide the various modules.

Further, the memory 24 may comprise a charging database 26 or information from such a database obtained from the databases 26 located in the cloud or otherwise. In one aspect, the charging database 26 may be configured to store information related to various power packs 12 used while charging and discharging from the ESU 10. In one aspect, the charging database 26 may be configured to store information related to the power cycle of each of the plurality of power packs 12, the maximum and minimum charge for different types of power packs 12, and the state of charge (SoC) profile of each of the plurality of power packs 12.

The charging database 26 may be configured to store information related to the management of the plurality of power packs 12, such as the type of power pack to be charged, safety specifications, recent performance data, bidirectional charging requirements or history of each of the plurality of power packs 12, etc. In another aspect, the stored information may also include, but is not limited to, the capacity of each of the plurality of power packs 12, amount of charge required for one trip of the device 16 along the path, such as golf course, etc., charging required for a supercapacitor unit, etc. In another aspect, the charging database 26 may provide a detailed research report for the device's average electric charge consumption over a path. In one aspect, the charging database 26 may be configured to store information of the consumption of the electric charge per unit per kilometer drive of the device 16 from the plurality of power packs 12. For example, such information may indicate that a golf cart is equipped with five supercapacitor-driven power packs 12 each at 90% charge, with each power pack able to supply a specified amount of ampere hours (Ah) of electric charge resulting in an ability to drive under normal conditions at top speed for, e.g., 80 kilometers. The information may also indicate that a solar cell installed on the roof of the golf cart would, under current partly clouded conditions, still provide enough additional charge over the planned period of use to extend the capacity of the ESU 10 by another 40 kilometers for 1 passenger.

The charging database 26 may be used by the performance module 54 for both reading data and storing new data on the individual energy storage units 10, such as the power packs 12.

### Power Pack

The power pack 12 is a unit that can store and deliver charge within an ESU 10 and comprises one or more supercapacitors such as supercapacitors in series and/or parallel. It may further comprise or cooperate with sensors 14, e.g., temperature sensors, charge and current sensors (circuits or other devices), connectors, switches such as crosspoint switches 32, safety devices, and control systems, such as charge and discharge control systems. In various aspects described herein, the power pack 12 may comprise a plurality of supercapacitors and have an energy density greater than 200 kWhr/kg, 230 kWhr/kg, 260 kWhr/kg, or 300 kWhr/kg, such as from 200 to 500 kWhr/kg, or from 250 to 500 kWhr/kg. The power pack 12 may have a functional temperature range from −70° C. to 150° C., such as from −50° C. to 100° C. or from −40° C. to 80° C. The voltage provided by the power pack may be any practical value such as 3V or greater, such as from 3V to 240 V, 4V to 120 V, etc.

By way of example, a power pack 12 may comprise one or more units each comprising at least one supercapacitor having a nominal voltage from 2 to 12 V such as from 3 to 6 V, including supercapacitors rated at about 3, 3.5, 4, 4.2, 4.5, and 5 V. For example, a power pack 12 may be provided with 14 capacitors in series and five series in parallel and charged with 21,000 F at 4.2 V to provide 68-75 Wh. Power packs 12 may be packaged in protective casings that allow them to be easily removed from an ESU 10 and replaced. They may also comprise connectors for charging and discharging. Power packs 12 may be provided with generally rectilinear casings or they may have cylindrical or other useful shapes.

### Supercapacitors

Principles for the design, manufacture, and operation of supercapacitors included in one or more power packs 12 are described, by way of example, in U.S. Pub. No. 2019/0180949, “Supercapacitor,” published Aug. 29, 2017 by Liu Sizhi et al. and PCT Pub. No. WO2018041095, “Supercapacitor,” published Mar. 8, 2018 by Liu Sizhi et al.; U.S. Pat. No. 9,318,271, “High temperature supercapacitor,” issued Apr. 19, 2016 to S. Fletcher et al.; US20150047844, “Downhole supercapacitor device”; U.S. Pub. No. 2020/0365336, “Energy storage device Supercapacitor and method for making the same”; U.S. Pat. No. 9,233,860, “Supercapacitor and method for making the same”; and U.S. Pat. No. 9,053,870, “Supercapacitor with a meso-porous nano graphene electrode.” Also see Chinese Pat. No. CN 106252099B, “Supercapacitor” by Liu Sizhi et al., published Apr. 10, 2018; Chinese Pat. No. CN 106252096B, “Supercapacitor” by Liu Sizhi et al., published Jan. 23, 2018; and Chinese Pat. No. CN 104057901B, “Automobile Power-supply Management System with Supercapacitor” by Yang Weiming et al., published Apr. 27, 2016.

A supercapacitor may have two electrode layers separated by an electrode separator wherein each electrode layer is electrically connected to a current collector supported upon an inert substrate layer, an electrolyte-impervious layer disposed between each electrode layer and each conducting layer to protect the conducting layer, and a liquid electrolyte disposed within the area occupied by the working electrode layers and the electrode separator. The liquid electrolyte may be an ionic liquid electrolyte gelled by a silica gellant or other gellant to inhibit electrolyte flow.

The supercapacitor may comprise an electrode plate, an isolation film, a pole, and a shell, wherein the electrode plate comprises a current collector and a coating is disposed on the current collector. The coating may comprise an active material that may include carbon nanomaterial, such as graphene or carbon nanotubes, including nitrogen-doped graphene, a carbon nitride, carbon materials doped with a sulfur compound, such as thiophene or poly 3-hexylthiophene etc., or graphene on which is deposited nanoparticles of metal oxide such as manganese dioxide. The coating may further comprise a conductive polymer, such as one or more of polyaniline, polythiophene and polypyrrole. Such polymers may be doped with a variety of substances including boron (especially in the case of polyaniline). Nitrogen doping, for example, is described more fully by Tianquan Lin et al, “Nitrogen-doped mesoporous carbon of extraordinary capacitance for electrochemicalenergy storage,” Science (new series), vol. 350, no. 6267 (18 Dec. 2015): 1508-1513, https://www.jstor.org/stable/24741499.

Electrodes in supercapacitors may have thin coatings in electrical communication with a current collector. To provide high electrode surface area for high performance, electrodes may comprise porous material with high specific surface area such as graphene, graphene oxide, or various derivatives of graphene, carbon nanotubes or other carbon nanomaterials including activated carbon, nitrogen doped graphene or other doped graphene, graphite, carbon fiber-cloth, carbide-derived carbon, carbon aerogel, and/or may comprise various metal oxides such as oxides of manganese, etc., and all such materials may be provided in multiple layers and generally planar, cylindrical, or other geometries. Electrolytes in the supercapacitor may include semi-solid or gel electrolytes, conductive polymers or gels thereof, ionic liquids, aqueous electrolytes, and the like. Solid-state supercapacitors may be used.

Supercapacitors may be provided with various indicators and sensors 14 pertaining to charge state, temperature, and other aspects of performance and safety. An actuation mechanism may be integrated to prevent undesired discharge.

The voltage of an individual supercapacitor may be greater than 2 V such as from 2.5 V to 5 V, 2.7 V to 8 V, 2.5 V to 4.5 V, etc.

### Powered Devices

Powered devices 16 that may be powered by the ESU 10 can include electric vehicles and other transportation devices of all kinds, such as those for land, water, or air, whether adapted to operate without passengers or with one or more passengers. Electric vehicles may include, without limitation, automobiles, trucks, vans, fork lifts, carts, such as golf carts or baby carts, motorcycles, electric bikes scooters, autonomous vehicles, mobile robotic devices, hoverboards, monowheels, Segways® and other personal transportation devices, wheelchairs, drones, personal aircraft for one or more passengers and other aeronautical devices, robotic devices, aquatic devices such as boats or personal watercraft such as boats, Jet Skis®, diver propulsion vehicles or underwater scooters, and the like. The electric vehicle generally comprises one or more motors connected to the ESU 10 and ECS 20 that controls the power delivered from the ESU 10, and may comprise a user interface that provides information and/or control regarding the delivery of power from the ESU 10 as well as information regarding performance, remaining charge, safety, maintenance, security, etc. Not all transportation devices require non-stationary motors. An elevator, for example, may have a substantially stationary motor while the cabin moves between level of a structure. Other transport systems with mobile cabins, seats, or walkways may be driven by stationary motors driving cables, chains, gears, bands, etc.

Principles for the manufacture and design of electric vehicles and aspects of their charging are provided in U.S. Pub. No. 2019/0061541, “Electric vehicle batteries and stations for charging batteries”; European Pat. No. EP2278677B, “Safety Switch for Secondary Battery for Electric Vehicle and Charging/Discharging System for Secondary Battery for Electric Vehicle Using the Same”; U.S. Pub. No. 2019/0061541, “Electric vehicle batteries and stations for charging batteries,” etc. The relationship between the ESU 10 and the drive train, especially when individual control of wheel speed is provided, can be optimized with neural network systems for traction control and efficiency. See Abdelhakim Haddoun, “Modeling, Analysis, and Neural Network Control of an EV Electrical Differential,” IEEE TRANSACTIONS ON INDUSTRIAL ELECTRONICS, vol. 55, no. 6 (June 2008): 2286-94, https://www.researchgate.net/publication/3219993.

Apart from electric vehicles, there are many other devices 16 that may be powered by the ESU 10 in cooperation with the ECS 20. Such other devices can include generators, which in turn can power an endless list of electric devices in households and industry. ESUs 10 of various size and shape can also be integrated with a variety of motors, portable devices, wearable or implantable sensors, medical devices, acoustic devices such as speakers or noise cancellation devices, satellites, robotics, heating and cooling devices, lighting systems, rechargeable food processing tools and systems of all kinds, personal protection tools such as tasers, lighting and heating systems, power tools, computers, phones, tablets, electric games, etc. In some versions, the device being powered is the grid, and in such versions, the ESU 10 may comprise an inverter to turn DC current into AC current suitable for the grid.

In some aspects, a plurality of devices 16, such as electric vehicles, may be networked together via a cloud-based network, wherein the devices 16 share information among themselves and/or with a central message center 62 such that an administrator can assist in managing the allocation of resources, oversee maintenance, evaluate performance of vehicles and ESUs 10, upgrade software or firmware associated with the ECS 20 to enhance performance for the particular needs of individual users or a collective group, adjust operational settings to better cope with anticipated changes in weather, traffic conditions, etc., or otherwise optimize performance.

### Implementation in Hybrid Vehicles

When installed in electric vehicles, the ESU 10 may comprise both power packs 12, as well as one or more lead-acid batteries or other batteries. The ESU 10 may power both the motor as well as the on-board power supply system.

### Motors

Any kind of electric motor may be powered by the ESU 10. The major classes of electric motors are: 1) DC motors, such as series, shunt, compound wound, separately excited (wherein the connection of stator and rotor is done using a different power supply for each), brushless, and PMDC (permanent magnet DC) motors, 2) AC motors, such as synchronous, asynchronous, and induction motors (sometimes also called asynchronous motors), and 3) special purpose motors, such as servo, stepper, linear induction, hysteresis, universal (a series-wound electric motor that can operate on AC and DC power), and reluctance motors.

### Display Interface

The display interface 64 of the ECS 20 may be displayed on or in the device 16, such as on a touch screen or other display in a vehicle or on the device 16, or it may be displayed by a separate device, such as the user's phone. The display interface 64 may comprise or be part of a graphic user interface such the control panel (e.g., a touch panel) of the device 16. The display interface may also comprise audio information and verbal input from a user. It may also be displayed on the ESU 10 itself or on a surface connected to or in communication with the ESU 10. In one version, the display interface 64 may include, but is not limited to, a video monitoring display, a smartphone, a tablet, and the like, each capable of displaying a variety of parameters and interactive controls, but the display interface 64 could also be as simple as one or more lights indicating charging or discharging status and optionally one or more digital or analog indicators showing remaining useful lifetime, % power remaining, voltage, etc. Further, the display interface 64 may be any state-of-the-art display means without departing from the scope of the disclosure. In some aspects, the display interface 64 provides graphical information on charge status, including one or more of fraction of charge remaining or consumed, remaining useful life of the ESU 10 or its components (e.g., how many miles of driving or hours of use are possible based on current or projected conditions or based on an estimate of the average conditions for the current trip or period of use), and may also provide one or more user controls to allow selection of settings. Such settings may include low, medium, or high values for efficiency, power, etc.; adjustment of operating voltage when feasible; safety settings (e.g., prepare the ESU 10 for shipping, discharge the ESU 10, increase active cooling, only apply low power, etc.); planned conditions for use (e.g., outdoors, high-humidity, in rain, underwater, indoors, etc.). Selections may be made through menus and/or buttons on a visual display, through audio presentation of information responsive to verbal commands, or through text commands or displays transmitted to a phone or computer, including text messages or visual display via an app or web page.

Thus, the ESU 10 may comprise a display interface 64 coupled to the processor 22 to continuously display the status of charging and discharging the plurality of power packs 12.

### Solar Power and Alternative Energy Systems

The ESU 10 may receive energy from solar panels coupled through one or more solar regulators and/or inverters. Solar panels produce electrical power through the photovoltaic effect, converting sunlight into DC electricity. This DC electricity may be fed to a battery via a solar regulator to ensure proper charging and prevent damage to the power pack 12. While DC devices can be powered directly from the battery or the regulator, AC devices require an inverter to convert the DC electricity to suitable AC current at, for example, 110V, 120V, 220V, 240V, etc.

Solar panels may be wired in series or in parallel to increase voltage or current, respectively. The rated terminal voltage of, e.g., a 12 Volt solar panel may actually be around 17 Volts, but the regulator may reduce the voltage to a lower level required for battery charging.

### Solar Regulators

Solar regulators (also called charge controllers) regulate current from the solar panels to prevent battery overcharging, reducing, or stopping current as needed. They may also include a Low Voltage Disconnect feature to switch off the supply to the load when battery voltage falls below the cut-off voltage and may also prevent the battery sending charge back to the solar panel in the dark.

Regulators may operate with a pulse width modulation (PWM) controller, in which the current is drawn out of the panel at just above the battery voltage, or with a maximum power point tracking (MPPT) controller, in which the current is drawn out of the panel at the panel “maximum power voltage,” dropping the current voltage like a conventional step-down DC-DC converter, but adding the “smart” aspect of monitoring of the variable maximum power point of the panel to adjust the input voltage of the DC-DC converter to deliver optimum power.

### Inverters

Inverters are devices that convert the DC power to AC electricity. They come in several forms, including on-grid solar inverters that convert the DC power from solar panels into AC power which can be used directly by appliances or be fed into the grid. Off-grid systems and hybrid systems can also provide power to batteries for energy storage but are more complex and costly that on-grid systems, requiring additional equipment. An inverter/charger that manages both grid connection and the charging or discharging of batteries may be called interactive or multi-mode inverters. A variation of such inverters is known as the all-in-one hybrid inverter.

Output from inverters may be in the form of a pure sine wave or a modified sine wave or square wave. Some electronic equipment may be damaged by the less expensive modified sine wave output. In many conventional systems, multiple solar panels are connected to a single inverter in a “string inverter” setup. This can limit system efficiency because, when one solar panel is shaded and has reduced power, the overall current provided to the inverter is likewise reduced. String solar inverters are provided in single-phase and three-phase versions.

Microinverters are miniature forms of inverters that can be installed on the back of individual solar panels, providing the option for AC power to be created directly by the panel. For example, LG (Seoul, Korea) produces solar panels with integrated microinverters. Unfortunately, microinverters limit the efficiency of battery charging because the AC power from the panels must be converted back to DC power for battery charging. They also add significant cost to the panels. The additional equipment on the panel may also increase maintenance problems and possibly the risk of lightning strikes. Microinverters generally use maximum power point tracking (MPPT) to optimize power harvesting from the panel or module it is connected to. An example of a microinverter is the Enphase M215 of Enphase Energy (Fremont, Calif.).

The on-grid string solar inverters and microinverters, collectively often simply called solar inverters, provide AC power that can be fed to the grid or directly to a home or office. Alternatively, off-grid inverters (or “battery inverters”) or hybrid inverters can charge batteries. Hybrid inverters can be used to charge batteries with DC current and to provide AC current for the grid or local devices, combining a solar inverter and battery inverter/charger into a single unit. An example of a hybrid inverter is the Conext SW 120/240 VAC hybrid inverter charger 48 VDC (865-4048) by Schneider Electric (Rueil-Malmaison, France) is a 4 kW (4000 watt) pure sine wave inverter or the 2.3 kW Outback Power Hybrid On/Off-grid Solar Inverter Charger 1-Ph 48 VDC by Outback Power (Phoenix, Ariz.).

### Machine Learning and AI

The ECS 20 or central systems in communication with the ECS 20 may employ machine learning, including neural networks and other AI systems, to learn performance profiles for individual power packs 12, including supercapacitors, or entire ESUs 10, or those of a managed fleet of vehicles of collection of devices 16, in order to better estimate and optimize performance including such factors as remaining charge, remaining useful life, times for maintenance, methods for charge control to reduce overheating or to prevent other excursions or safety issues, and strategies to optimize lifetime or power delivery with a given ECS 20. Methods for adaptive learning, neural network analysis, or AI development that can be used with supercapacitor systems or the ESUs 10 described herein include Jean-Noël Marie-Françoise et al., “Supercapacitor modeling with Artificial Neural Network (ANN),” https://www.osti.gov/etdeweb/servlets/purl/20823689, accessed Nov. 1, 2021, which describes an Artificial Neural Network (ANN) using a black box nonlinear multiple inputs single output (MISO) model in which the system inputs are temperature and current, the output is the supercapacitor voltage. See also Elena Danila et al., “Dynamic Modelling of Supercapacitor Using Artificial Neural Network Technique,” International Conference and Exposition on Electrical and Power Engineering, October 2014, DOI: 10.1109/ICEPE.2014.6969988 and https://www.researchgate.net/publication/270888480_Dynamic_Modelling_of_Supercapacitor_Using_Artificial_Neural_Network_Technique, which describes a feed forward artificial neural network structure with two hidden layers and with backpropagation training. Similar systems may be adapted for anticipatory power control as described herein. Also see Akram Eddahech, “Modeling and adaptive control for supercapacitor in automotive applications based on artificial neural networks,” Electric Power Systems Research, vol. 106 (January 2014): 134-141, https://www.sciencedirect.com/science/article/abs/pii/S0378779613002265, which seeks to predict power cycle behavior for supercapacitors using a one-layer feed-forward artificial neural network (ANN). Related publications include U.S. Pub. No. 20190097362, “Configurable Smart Object System with Standard Connectors for Adding Artificial Intelligence to Appliances, Vehicles, and Devices,” published Mar. 28, 2019 by B. Haba et al.; U.S. Pat. No. 9,379,546, “Vector control of grid-connected power electronic converter using artificial neural networks,” issued Jun. 28, 2016 to S. Li et al.; U.S. Pat. No. 7,548,894, “Artificial neural network,” issued Jun. 16, 2009 to Y. Fuji; and U.S. Pub. No. 20160283842, “Neural Network and Method of Neural Network Training United,” issued Sep. 29, 2016 to D. Pescianschi.

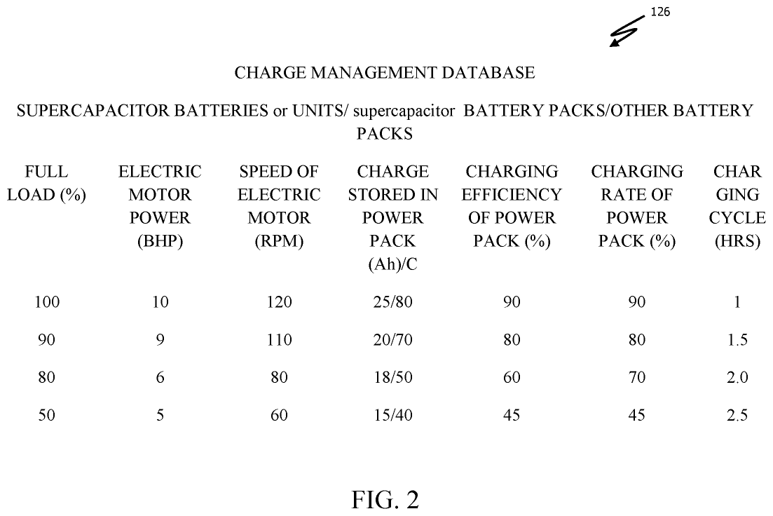

FIG. 1B is block diagram of an integrated power system 100 for an electric vehicle (shown in FIG. 1A), according to an embodiment of the present disclosure. FIG. 1B is described in conjunction with FIGS. 2-9 and includes some of the elements of FIG. 1A. In one embodiment, the integrated power system 100 may be referred to as a system providing integrated power supply management within the electric vehicle. The electric vehicle may include, but is not limited to, a golf cart, a baby cart, an electric car, and an electric bike. Further, the integrated power system 100 may provide smart energy management to supply electric charge to the electric vehicle from the power pack in a controlled manner in order to maximize the efficiency of charge.

The integrated power system 100 may include an energy control system (ECS) 101 adapted to regulate an energy storage unit (ESU) 107 associated with the electric vehicle. The ESU 107 may include energy storage devices, such as supercapacitor power packs 110 and optionally other energy sources, such as secondary supercapacitor power packs 112 and/or battery packs 116. The ESU 107 may also comprise thermal control hardware 111 for preventing damage from excessive temperatures in the supercapacitor power packs 110, 112, as well as power control circuits 117, power leads 114, and so forth.

The ECS 101 may comprise a processor 102 coupled with a display interface 104. Further, the integrated power system 100 may comprise an electric motor 106 to generate power and drive the electric vehicle. The electric motor 106 may include an electric motor housing 108, supercapacitor power packs 110, a power leads 114 (and other related hardware such as insulated wires, switches, etc.), and one or more battery packs 116. Further, the electric motor 106 may be communicatively coupled with the processor 102. The electric motor 106 may also be communicatively coupled with a connection interface 120. The connection interface 120 may include a connection interface manager 122, which oversees the connections and communication between the components or modules of the ECS 101 with themselves and with the electric motor 106 or the ESU 107. Further, the integrated power system 100 may include a memory unit 124 with a charge management database 126 and other databases, as needed. In one embodiment, the memory unit 124 may be communicatively coupled with the processor 102.

The display interface 104 is configured to display the charge level of the battery pack 116 of the electric vehicle or other information pertaining to the status and operation of the ESU 107 and its modules and/or settings and commands for the ESU 107. For example, the display interface 104 may be configured to display the charging rate or discharging rate of the electric motor 106 and the battery pack 116. Further, the display interface 104 may be configured to display the charge level of the electric motor 106 and information related to the charge level required for the battery pack 116. Further, the processor 102 may be configured to control the operation of charging and discharging the battery pack 116 of the electric vehicle.

During charging and discharging of the both the motor-mounted supercapacitor power packs 110 and secondary power packs 112, temperature and other properties of the power packs may be continuously monitored by various thermal sensors (thermistors, thermocouples, infrared sensors, etc.) to detect the emergence of potentially harmful hotspots, or to ensure that the supercapacitors are operating at an acceptable temperature. For local or system overheating, the thermal control hardware 111 in cooperation with the thermal management module 135 may apply various cooling mechanisms, such as fans, Peltier effect coolers, forced liquid flow systems with heat transfer liquids, fins, etc., to cool overheated regions, while the thermal management module 135 may also reduce the charging or discharging of individual supercapacitors to reduce the sources of overheating. The thermal management module 135 may also assist in coping with cold weather by providing heating when temperatures of supercapacitors are below the useful temperature range or too cold to provide a needed level of charge for starting or other demanding actions (e.g., at temperatures less than −10° C., −20° C., −30° C., etc.). In such cases, electrical power from a low temperature power source (LTPS) 113 that is part of or operably associated with the thermal control hardware 111 and/or responsive to the thermal management module 135 may be applied from the LTPS 113 to one or more supercapacitors in either the motor-mounted supercapacitor power packs 110 or the secondary supercapacitor power packs 112 or both in order to bring sufficient power packs up to a required temperature in order to start the engine or perform other operations. The LTPS may include supercapacitors, such as solid-state supercapacitors, supercapacitors with low-temperature ionic fluid electrolytes, and/or low-temperature supercapacitors with foam or aerogel structures, such as those described in Bin Yao et al., “Printing Porous Carbon Aerogels for Low Temperature Supercapacitors,” Nano Letters, vol. 21, no. 9 (Mar. 10, 2021): 3731-3737, https://pubs.acs.org/doi/abs/10.1021/acs.nanolett.0c04780 and https://doi.org/10.1021/acs.nanolett.0c04780. 0c04780. Alternatively, or in addition, the LTPS may include lithium thionyl chloride (LiSOCl2) batteries by Tadiran (Lake Success, N.Y.), which can operate at −100° C., low-temperature lithium-ion polymer batteries, such as those manufactured by Grepow, Inc. (Livermore, Calif.), which can operate at −50° C., and/or LiFePO4 batteries. Combustible fuels, such as butane, propane, gasoline, kerosene, etc., may also be used for temporary heating.

The power leads 114 may be coupled at one end to the supercapacitor power packs 110 and to the electric motor 106 at another end. In one embodiment, the power leads 114 may be configured to drive power from the supercapacitor power packs 110 and deliver power to the electric motor 106. Further, the electric motor 106 may provide a mechanism for the supercapacitor power packs 110 to generate, store, and deliver the power to different components of the electric vehicle. In one embodiment, the electric motor 106 integrated with the supercapacitor power packs 110 may be configured to eliminate unrealized power transfer or power loss. For example, the supercapacitor power packs 110 may be configured to store power during the braking cycle of the electric motor 106.

The supercapacitor power packs 110 may be provided with a countercurrent mechanism such that the energy flowing from the electric motor 106 towards the supercapacitor power packs 110 is being pulled towards the battery pack 116, after which energy may flow in the reverse direction from the battery pack 116 to the electric motor 106 via the supercapacitor power packs 110. The energy flowing from the electric motor 106 towards the supercapacitor power packs 110 may create a magnetic field surrounding the electric motor 106.

Further, the supercapacitor power packs 110 may be configured to store energy received from the electric motor 106 and deliver it to the battery pack 116. In one embodiment, the energy received may be in a form of potential energy during the braking cycle of the electric motor 106.

In one embodiment, the electric motor 106 may be provided with layers of the supercapacitor power packs 110, which may serve one or more purposes such as enhancing thermal performance (e.g., improved heat transfer to reduce overheating due to the excellent thermal conductivity of, for example, graphene or other carbon-based materials in the supercapacitor) and capacitive measures to deal with phase shift for power factor corrections.

In one embodiment, the electric motor 106 may be provided with supercapacitor power packs 110 that may conform in shape to (1) one interior motor housing space, (2) multiple interior motor housing shapes, (3) one exterior motor housing space (4) multiple exterior motor housing shapes and (4) any combination of interior and exterior single or multiple motor housing shapes. Supercapacitor power packs 110 can be produced by a process to form flexible layers of materials, that can be formed on a mandrel (not shown) where the mandrel is identical to the shapes discussed above.

Power factor corrections may be important for applications employing AC current, which may include delivery of power to one or more AC outlets associated with a vehicle or, more generally, the other loads 121 of FIG. 1B that can be powered by the ESU 107. Such powering may involve the use of inverters such as pure sine wave inverters (not shown) and other systems. The need for power factor corrections in AC power often arises from phase difference between current and voltage that can occur when there is an inductive load, leading to magnetic reversals and wasted energy. However, power control circuits (power correction circuits) with capacitors can be used to help store and recover some of this wasted energy. This can be important for induction motors, transformers, inductive furnaces, etc. Basic principles are described in “An Introduction to Capacitor-Based Power Factor Correction Circuits,” Passive Components Blog, Jul. 29, 2019, https://passive-components.eu/an-introduction-to-capacitor-based-power-factor-correction-circuits/.

The power factor is the ratio of active power (or useful power or working power) to total power (apparent power). A power factor less than 0.85 is generally considered poor. With suitable power factor compensation, good power factors of, e.g., 0.95 to 0.98 or 0.95 to 0.99 or higher may be achieved. Working power is often reported in kilowatts (kW), and reactive power is often reported in kilo-volt-amperes-reactive (kVAR). In some aspects, the combinations of supercapacitor power packs 110 to an electric motor with optional harmonic filters may substantially improve the power factor of an electric vehicle or other device. The power control circuits comprising supercapacitors may include one or more supercapacitors within the supercapacitor power packs 110 and may be regulated by a chip or other control devices (not shown) which may be operatively associated with a power optimization module 143 of the ECS 101. The regulating of the power control circuits may include turning the power control circuit on or off via switches or other means when needed and/or adjusting the amount of capacitance in the circuit and/or the application of harmonic filters or other tools to achieve an improved power factor, and may include measurement of the power factor or related characteristics of power delivery, including apparent power, useful power, impedance, inductive reactance, capacitive reactance, non-linearity of voltage and current, spectral features or other characteristics of electronic noise, etc. In particular, the power optimization module 143 may oversee measurement of power characteristics and measures to improve the power factor, the waveform, etc., for output power and may include active power filtering, harmonic filtering, etc.

Power factor is the ratio of the actual electrical power dissipated by an AC circuit to the product of the RMS values of current and voltage. The difference between the two is caused by reactance in the circuit and represents power that does no useful work. Power factor measurements in some cases if the DC supercapacitors batteries get converted to AC run the motor.

A suitable capacitor corrects the power factor by releasing a leading current to compensate the lagging current when there is a phase shift, in effect neutralizing the magnetic current and reducing associated losses. A poor power factor may also be caused by distorted current waveform, which may be at least partially corrected through the use of harmonic filters.

In another embodiment, the layers of the supercapacitor power packs 110 may assist with both thermal management and phase-shifting for power factor corrections. In some embodiments the supercapacitors as units of combined supercapacitors and the units have subunits of supercapacitors. Thermal management may in particular be achieved through the high thermal conductivity of certain power packs, such as those with, e.g., 5% or more graphene materials.

Another aspect of thermal management is controlling the charging or discharging of supercapacitor power packs to prevent potentially harmful hot spots, where local temperature measurement or measurement of other indications of hot spots can be used in association with the ECS 101 to reduce the charging or discharging of individual power packs or, in some versions, of individual supercapacitors, and/or may involve increasing cooling such as by a fan or forced flow of a liquid in response to hot spot formation, to directly cope with potential overheating. Thermal management may also include heating, especially electric heating, in cold weather to ensure the supercapacitors are in suitable condition to provide the needed charge for starting or other operations. In one aspect, the ESU 107 includes at least one low-temperature power source for the thermal management system In another embodiment, thermal management may be referred to as the management of heat generated during the transfer of energy from the electric motor 106 towards the supercapacitor power packs 110.

In one alternate embodiment, the integrated power system 100 may be provided with a flattened curve due to dosing and P-N junction to deliver energy from the supercapacitor power packs 110 to the battery pack 116. It can be noted that the P-N junction may act as a controllable junction that can be turned on and off according to the energy stored with the supercapacitor power packs 110. In one embodiment, the flattened curve may be provided to detect the charge level of the battery pack 116. Further, the P-N junction may be based on the potential voltage across the supercapacitor power packs 110. In one embodiment, each supercapacitor power pack 110 may be turned on and off via the P-N junction. In one embodiment, the supercapacitor power packs 110 may be a programmable energy subsystem between the electric motor 106 and the battery pack 116. It can be noted that the P-N junction can be programmed for an ideal range of the power capacity generated from the electric motor 106.

In one alternate embodiment, the electric motor 106 may be designed to integrate a plurality of annular rings for thermal, electrical, and/or opportunistic management to bring controls to the electric motor 106, itself. Each of the plurality of annular rings may be provided with localized magnetics disposed on the inner side of each annular ring for high torque generation. In another embodiment, the outer side of each annular ring may provide a space for additional supercapacitors.

In another alternate embodiment, the electric motor 106 may be provided with a heat pipe coupled with the supercapacitor power packs 110 to manage the thermal properties of the supercapacitor power packs 110. In one embodiment, the heat pipe may be configured to channel heat away from hotspots around the electric motor 106 and transfer the heat to desired regions. In one embodiment, the electric motor 106 may be integrated with a plurality of molded fins around the outer circumference of the electric motor 106 to remove heat generated during acceleration and/or deceleration of the electric motor 106. In one embodiment, each of the plurality of molded fins may be multi-tiered with a different pitch and length. In another embodiment, the heat pipe may be integrated over an alternating current (AC) motor when a direct current source is being supplied after conversion from a multi-phased current source. In one embodiment, the plurality of molded fins may be provided to generate cooling inside the electric motor 106 and the supercapacitor power packs 110.

Further, the electric motor 106 may be provided with a graphene film based supercapacitors for supercapacitor powerpacks 110.

In one alternate embodiment, the supercapacitor power packs 110 may be designed as a part of the electric motor 106 armature. Further, electric motor 106 may be a cylindrical structure with the supercapacitor power packs 110 integrated on one side of the cylindrical structure, and the other side integrated with a commentator ring.

The connection interface 120 is mainly used for facilitating the connection of the battery pack 116 and the connection of the supercapacitor power packs 110 with the electric motor 106. The connection interface 120 may include the connection interface manager 122 which enables the connection interface 120 to manage the connection of the supercapacitors in the battery pack 116 or the connection of the supercapacitor power packs 110 with the electric motor 106. For instance, there may be 10 supercapacitors connected with the motor but there could be a maximum of 30 supercapacitors that can be connected with the motor 106. This connection of one component with the other component is managed by the connection interface manager 122.

In one embodiment, the integrated power system 100 may be configured to determine the charge level required by the supercapacitor power packs 110 of the electric vehicles in order to manage energy in the battery pack 116 of the electric vehicle. In one embodiment, the integrated power system 100 may be configured to manage the energy of the battery pack 116 of the electric vehicle.

In one embodiment, the integrated power system 100 may provide smart energy management to supply electric charge to the electric motor 106 from the supercapacitor power packs 110 in a controlled manner, in order to maximize the efficiency of charge. Further, the integrated power system 100 may also provide a real-time charging and/or discharging of the supercapacitor power packs 110 while the electric vehicle may be continuously accelerating and decelerating along a path. In one embodiment, the integrated power system 100 may be referred to as a modular graphene power pack for the electric vehicle whose energy is managed by a combination of the electric motor 106 with the supercapacitor power packs 110 integrated onto the electric motor 106. In one embodiment, the battery pack 116 of the integrated power system 100 may include chemical and nonchemical batteries, such as, but not limited to, supercapacitors.

Further, the integrated power system 100 may include the memory unit 124 communicatively coupled to the processor 102 via the network interface 118. Further, the memory unit 124 may be configured to receive a set of instructions from the processor 102 while charging and discharging the supercapacitor power packs 110. In one embodiment, the set of instructions may be to facilitate activation of a charging mode and/or a discharging mode to charge and/or discharge the supercapacitor power packs 110. It can be noted that the network interface 118 may facilitate a communication link among the components of the integrated power system 100. It can be noted that the network interface 118 may be a wired and/or a wireless network. The network interface 118, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques, known in the art.

The charge management database 126 described in FIG. 2 may be configured to store information related to the supercapacitor power packs 110 while charging and discharging from the integrated power system 100. In one embodiment, the charge management database 126 may be configured to store information related to the power cycle of each of the motor-mounted supercapacitor power packs 110 or the secondary supercapacitor power packs 112, the maximum charge and the minimum charge for different types of the supercapacitors, and state of charge (SoC) profile of each of the supercapacitor power packs 110, 112. In one embodiment, the display interface 104 may be integrated within the electric vehicle to display charging and discharging of the supercapacitor power packs 110, 112. In one embodiment, the display interface 104 may include, but not limited to, a video monitoring display, a smartphone, a tablet, and alike.

Further, the charge management database 126 may be configured to store information related to the management of the supercapacitor power packs 110, 112 and the battery pack 116 of the electric vehicle. In one embodiment, the information may include, without limitation, the type of power pack to be charged, bidirectional charging of each of the supercapacitor power packs 110, 112, energy presently available in the battery pack 116 of the electric vehicle, the minimum energy required in the battery pack 116 of the electric vehicle, the power capacity of the electric motor 106, etc. In another embodiment, the stored information may also include, but is not limited to, the capacity of each of the supercapacitor power packs 110, amount of charge required for one trip of the electric vehicle along a path, charging required for the battery pack 116 of the electric vehicle, amount of power transfer from the electric motor 106 to the battery pack 116 of the electric vehicle and acceleration and deceleration data related to the path of the electric vehicle. In another embodiment, the charge management database 126 may provide a detailed report for an average electric charge consumption of the electric vehicle over the path. In one embodiment, the charge management database 126 may be configured to store information of the consumption of the electric charge per unit per kilometer drive of the electric vehicle from the supercapacitor power packs 110.

Further, the integrated power system 100 may include a plurality of modules to evaluate and enhance the performance of charging and discharging the capacity of the supercapacitor power packs 110. In one embodiment, the plurality of modules may enhance the performance of the electric vehicle by supplying the electric charge from the supercapacitor power packs 110 integrated with the electric motor 106, according to the desired need of the electric vehicle.

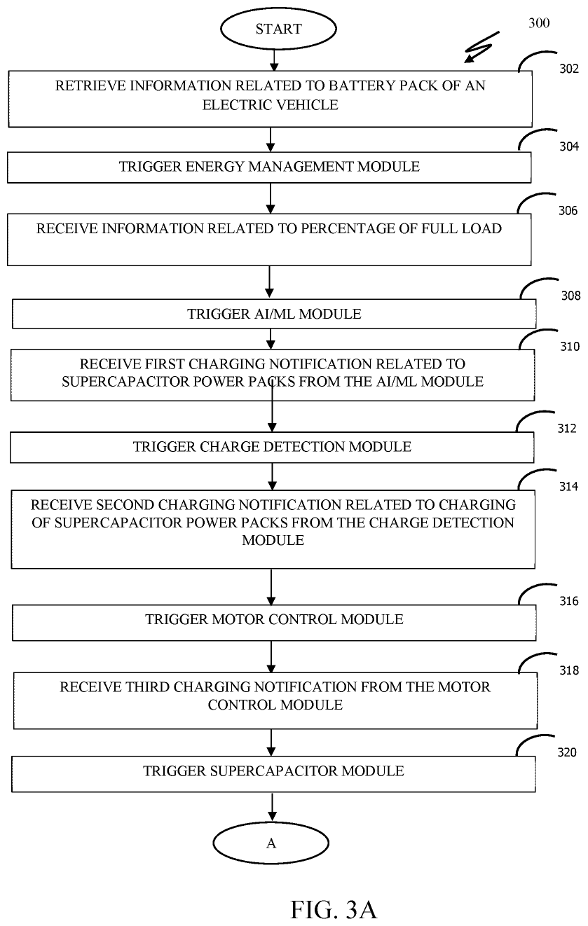

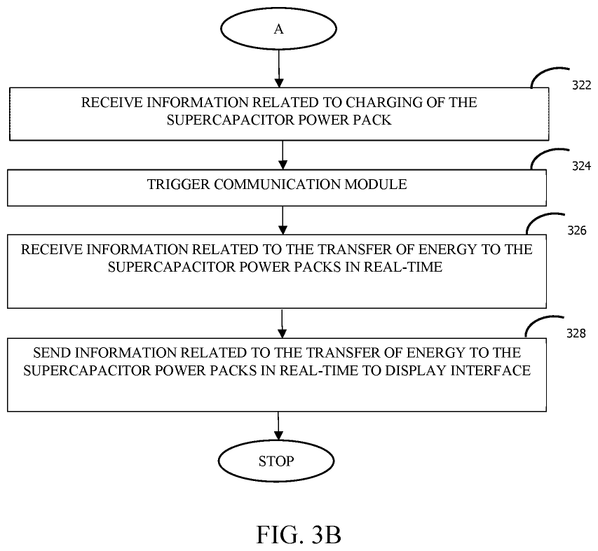

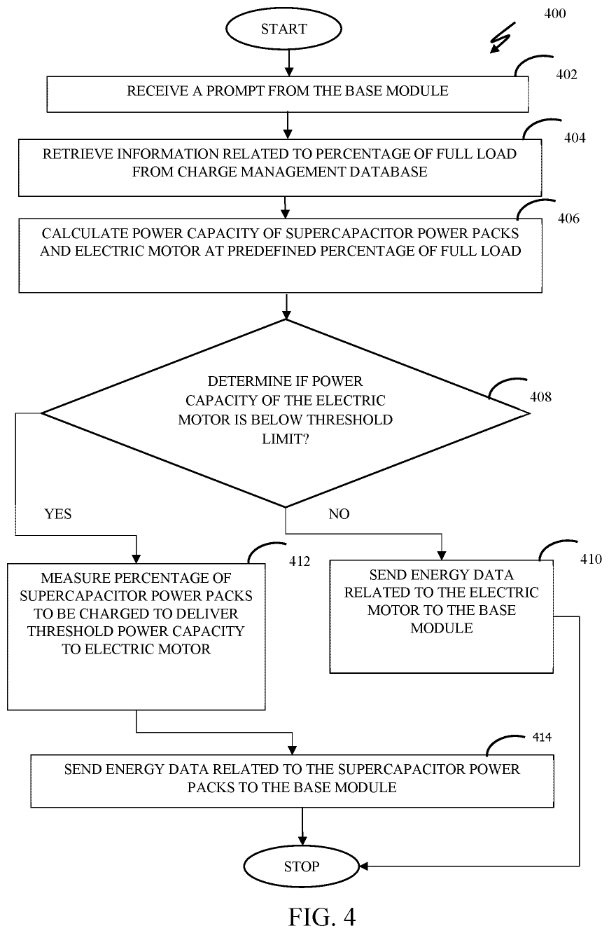

Further, the integrated power system 100 may include a base module 128 (which may reside in memory unit 124 or in a separate memory connected to the processor) communicatively coupled with the processor 102 and the memory unit 124 and with the ESU 107 and optionally with the network interface 118. In one embodiment, the base module 128 may be configured to manage parameters related to the supercapacitor power packs 110, 112, such as, without limitation, electric charge of the supercapacitor power packs 110, 112 and the performance of the motor-mounted supercapacitor power packs 110 when integrated with the electric motor 106 in the electric vehicle. Further, the base module 128 may be described in FIGS. 3A-3B. In one embodiment, the base module 128 may act as a central module to receive and send instructions to each of the plurality of modules. In one embodiment, the base module 128 may be configured to activate and/or deactivate a plurality of sub-modules according to the information received from the processor 102 and the memory unit 124. Further, the base module 128 may include an energy management module 130 configured to receive information related to the battery pack 116 of the electric vehicle through the base module 128. Further, the energy management module 130 is configured to determine the percentage of full load in real-time based on the information related to the battery pack 116 of the electric vehicle. The information related to the battery pack 116 of the electric vehicle includes the available charge present in the battery pack 116, backup storage and charge required to energize the battery pack 116, etc. It can be noted that the full load refers to the maximum capacity of the electric vehicle which can be accommodated by the electric vehicle. The energy management module 130 is described in FIG. 4.

Further, the base module 128 may include an Artificial Intelligence/Machine Learning (AI/ML) module 132 to receive data related to the percentage of full load and optimization of battery performance, supercapacitor performance, and output to other loads 121. Further, the AI/ML module 132 is configured to determine data related to the power capacity of the electric motor 106 corresponding to the percentage of full load. In one aspect, the AI/ML module 132 may also develop techniques for managing charge and discharge of supercapacitor power packs 110, 112 and the battery pack 116 to improve efficiency, reduce maintenance issues, improve safety, improve thermal management performance by the thermal management module 135 in cooperation with the thermal control hardware 111, etc., storing learned information in the charge management database 126 and/or databases related to the thermal management module 135, the supercapacitor module 138, and the energy management module 130.

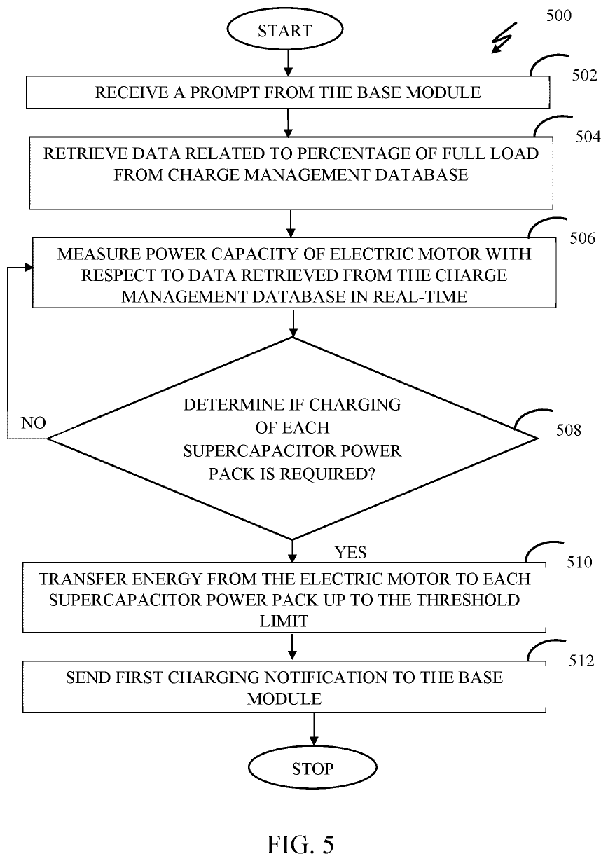

In one embodiment, the base module 128 may be configured to receive an input request from the energy management module 130 related to the requirement of the electric charge of the supercapacitor power packs 110. In one embodiment, the AI/ML module 132 may be activated and deactivated automatically by the base module 128 according to a request related to determining the percentage of full load from the energy management module 130. In one embodiment, the AI/ML module 132 may be configured to retrieve data related to each of the supercapacitor power packs 110 from the charge management database 126. In one embodiment, the data related to each of the supercapacitor power packs 110 may be an amount of electric charge stored in the each of the supercapacitor power packs 110. In another embodiment, the AI/ML module 132 may be configured to obtain information about the amount of the electric charge of each of the supercapacitor power packs 110 based on the data retrieved from the supercapacitor module 138 and/or the energy management module 130 and stored in the charge management database 126. Further, the AI/ML module 132 may determine whether charging is needed or not based on the percentage of full load corresponding to the information related to the battery pack 116 of the electric vehicle. The AI/ML module 132 is described in FIG. 5.

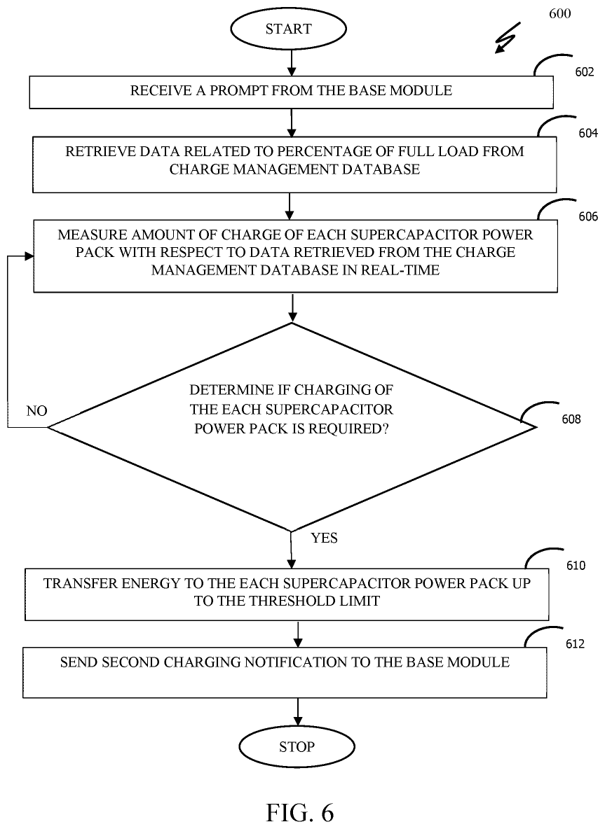

Further, the base module 128 may include a charge detection module 134 to evaluate and determine the charge level of each of the supercapacitor power packs 110 according to the percentage of full load determined by the energy management module 130. Further, the charge detection module 134 may be configured to receive information related to charging or discharging the supercapacitor power packs 110, based on the power capacity of the electric motor 106 determined by the AI/ML module 132. In one embodiment, the charge detection module 134 may analyze the charge level of each of the supercapacitor power packs 110 and determine the charging rate or discharging rate of the supercapacitor power packs 110. The charge detection module 134 is described in FIG. 6.

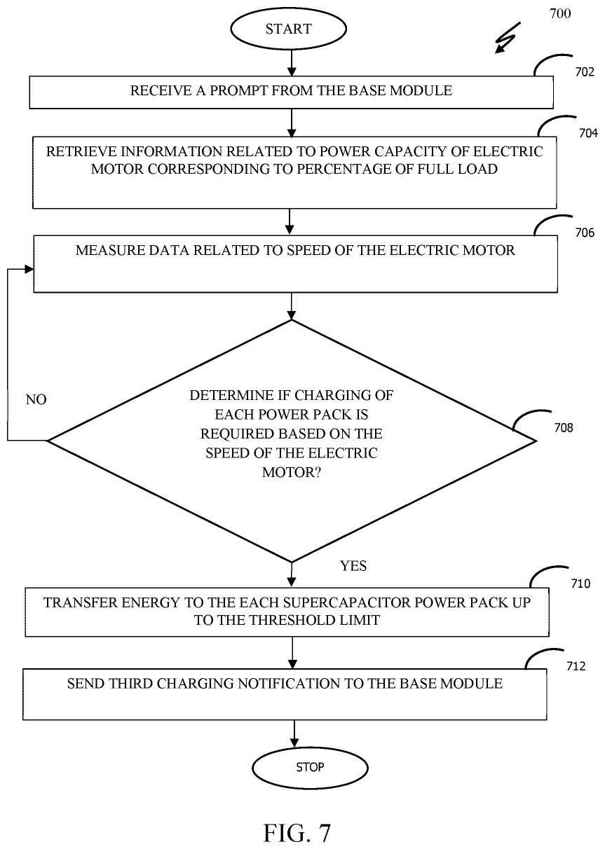

Further, the base module 128 may include a motor control module 136 to evaluate data related to the speed of the electric motor 106. The motor control module 136 is further configured to detect a change in the speed of the electric motor 106. The motor control module 136 is fed with AI/ML algorithm and takes into account detection, monitoring, anticipation and response to change in the speed of the electric motor 106 and various charging parameters of the electric motor 106. These charging parameters are current, voltage, inductance, and other power transfer parameters. The motor control module 136 is described in FIG. 7.

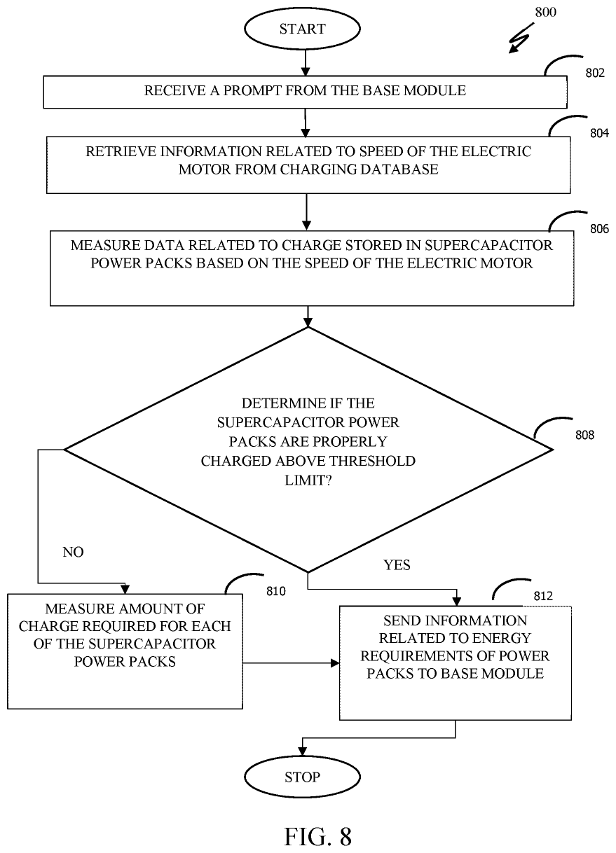

Further, the base module 128 may include a supercapacitor module 138 to evaluate and charge the supercapacitor power packs 110. In one embodiment, the base module 128 is configured to receive and manage data related to the charge stored in the supercapacitor power packs 110 in real-time. Further, the supercapacitor module 138 is configured to detect the difference in charge voltages between the supercapacitor power packs 110. In one embodiment, the supercapacitor module 138 may retrieve information from the charge management database 126 to evaluate the charge stored in the supercapacitor power packs 110 when connected for charging and/or discharging to the supercapacitor power packs 110. The supercapacitor module 138 is described in FIG. 8.

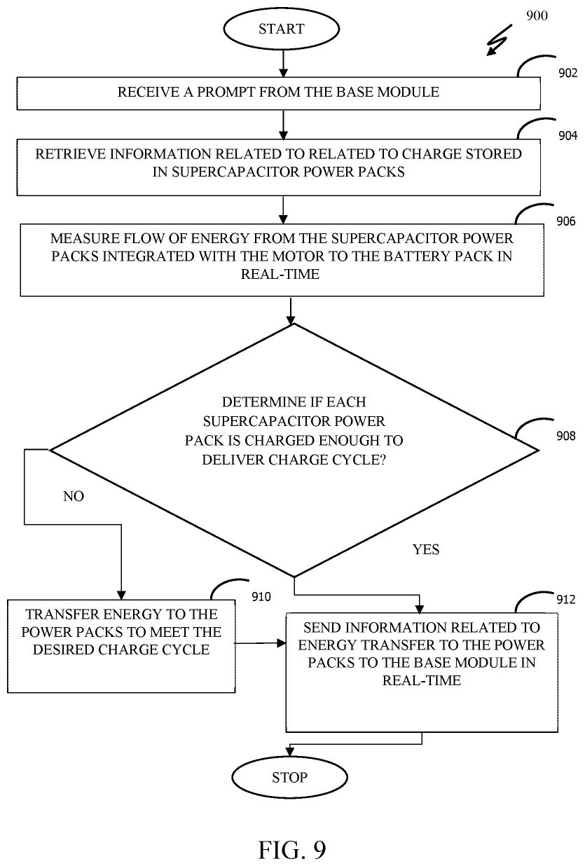

Further, the base module 128 may include a communication module 140 communicatively coupled to the energy management module 130, the AI/ML module 132, the charge detection module 134, the motor control module 136, and the supercapacitor module 138. Further, the communication module 140 may be configured to receive information related to the flow of energy from the supercapacitor power packs 110 integrated with the electric motor 106 to the battery pack 116 in real-time. The communication module 140 may be also configured to enable the transfer of energy from the supercapacitor power packs 110 to the battery pack 116 up to a threshold limit. In one embodiment, the threshold limit may be more than 90 percent capacity of each of the supercapacitor power packs 110. The communication module 140 is described in FIG. 9.

FIG. 2 illustrates the charge management database 126 according to an embodiment of the present disclosure. In one embodiment, the charge management database 126 may be configured to store information related to a variety of supercapacitor power packs 110 used while charging and discharging them from the electric motor 106. Further, the charge management database 126 may be configured to store information related to the power cycle of each of the supercapacitor power packs 110, the maximum charge and the minimum charge for a different type of the supercapacitor power packs 110, and state of charge (SoC) profile of each of the supercapacitor power packs 110.

In one embodiment, the energy management module 130 may be configured to charge each of the supercapacitor power packs 110, 112 when connected in series and/or parallel, relying on data from the charge management database 126 and other sources of information. In another embodiment, a charge management module (not shown) could use (read and store) the data in the charge management database 126 to control the charge of the supercapacitor power packs 110. In another embodiment, the charge management database 126 may also store the charging cycle of each of the supercapacitor power packs 110 when integrated with the electric motor 106. In one example, at 100% of full load, the power capacity of the electric motor 106 detected is 10 Brake Horse Power (BHP) and the speed of the electric motor 106 detected is 120 Rotations per Minute (RPM). Corresponding to this, the charge stored in each of the supercapacitor power packs 110 is 80 Coulombs (C). Hence, the charging efficiency of the battery pack 116 is 90 percent. Similarly, in yet one more example, at 90% of full load, the power capacity of the electric motor 106 detected is 9 BHP and the speed of the electric motor 106 detected is 110 Rotations per Minute (RPM). Corresponding to this, the charge stored in each of the supercapacitor power packs 110 is 70 C. Hence, the charging efficiency of the battery pack 116 is 80 percent. In yet another example, at 80% of full load, the power capacity of the electric motor 106 detected is 6 BHP and the speed of the electric motor 106 detected is 80 RPM. In this case, the charge stored in each of the supercapacitor power packs 110 is 50 C. Hence, the charging efficiency of the battery pack 116 is 60 percent. In yet another example, at 50% of full load, the power capacity of the electric motor 106 detected is 5 BHP and the speed of the electric motor 106 detected is 60 RPM. In this case, the charge stored in each of the supercapacitor power packs 110 is 40 C. Hence, the charging efficiency of the battery pack 116 is 45 percent.

In another embodiment, the charge management database 126 may be configured to store the charging rate of the supercapacitor power packs 110 and the charge cycle of the battery pack 116 of the electric vehicle. In one example, at 100% of full load, the power capacity of the electric motor 106 detected is 10 BHP and the speed of the electric motor 106 detected is 120 RPM. Corresponding to this, the charging rate of the supercapacitor power packs 110 is 90 percent. Hence, the charge cycle of the battery pack 116 is 1 hour. In yet one more example, at 90% of full load, the power capacity of the electric motor 106 detected is 9 BHP and the speed of the electric motor 106 detected is 110 RPM. Corresponding to this, the charging rate of the supercapacitor power packs 110 is 80 percent. Hence, the charge cycle of the battery pack 116 is 1.5 hours. In another example, at 80% of full load, the power capacity of the electric motor 106 detected is 6 BHP and the speed of the electric motor 106 detected is 80 RPM. Corresponding to this, the charging rate of the supercapacitor power packs 110 is 70 percent. Hence, the charge cycle of the battery pack 116 is two hours. In yet another example, at 50% of full load, the power capacity of the electric motor 106 detected is 5 BHP and the speed of the electric motor 106 detected is 60 RPM. Corresponding to this, the charging rate of the supercapacitor power packs 110 is 45 percent. Hence, the charge cycle of the battery pack 116 is 2.5 hours.

FIGS. 3A-3B illustrate a flowchart showing a method 300 performed by the base module 128, according to an embodiment. FIGS. 3A-3B are described in conjunction with FIGS. 1A-B, FIG. 2, FIG. 4, FIG. 5, FIG. 6, FIG. 7, FIG. 8, and FIG. 9. In one embodiment, the base module 128 may be configured to initiate each of the plurality of modules to enhance the performance and the capability of the supercapacitor power packs 110 and the electric motor 106, both integrated into each other. It should also be noted that in some alternative implementations, the functions noted in the blocks may occur out of the order noted in the drawings. For example, two blocks shown in succession in FIGS. 3A-3B may in fact be executed substantially concurrently or the blocks may sometimes be executed in the reverse order, depending upon the functionality involved. In addition, the process descriptions or blocks in flow charts should be understood as representing decisions made by a hardware structure such as a state machine.

At first, the base module 128 may be configured to retrieve information related to the battery pack 116 of the electric vehicle from the charge management database 126, at step 302. In one embodiment, the information related to the battery pack 116 may be the type of battery pack 116, duty cycle or charge cycle of the battery pack 116, the capacity of the battery pack 116 to store the electric charge, charge available in the battery and amount of charge required by the battery to get energized. For example, the base module 128 retrieves information from the charge management database 126 that a supercapacitor battery is coupled to the electric vehicle, and the charge management database 126 states that the charge cycle of the supercapacitor battery is one hour, and the supercapacitor battery has available charge of 80 C, and when charged to its maximum power capacity of 10 BHP, delivers the electric charge of 80 C for one hour in order to be energized. Further, the base module 128 may trigger the energy management module 130, at step 304. Further, the energy management module 130 is described in FIG. 4.

FIG. 4 illustrates a flowchart of a method 400 performed by the energy management module 130. It should also be noted that in some alternative implementations, the functions noted in the blocks may occur out of the order noted in the drawings. For example, two blocks shown in succession in FIG. 4 may in fact be executed substantially concurrently or the blocks may sometimes be executed in the reverse order, depending upon the functionality involved. In addition, the process descriptions or blocks in flow charts should be understood as representing decisions made by a hardware structure such as a state machine.

At first, the energy management module 130 may receive a prompt from the base module 128, at step 402. In one embodiment, the energy management module 130 may be configured to identify the type of the battery pack 116 and the capacity of the battery pack 116 of the electric vehicle. Further, the energy management module 130 may be configured to retrieve information related to the percentage of the full load from the charge management database 126, at step 404. In one embodiment, the energy management module 130 retrieves information from the charge management database 126 that the supercapacitor power packs 110 connected to the integrated power system 100 are supercapacitor units. For example, the energy management module 130 retrieves that ten supercapacitor units are connected in series. Successively, the energy management module 130 may calculate the power capacity of supercapacitor power packs 110 and the electric motor 106 at a predefined percentage of full load, at step 406. In one embodiment, the predefined percentage of the full load may vary according to the available electric charge within the supercapacitor power packs 110, 112 and the batter pack 116 for consumption by the electric motor 106. For example, the energy management module 130 calculates that the power capacity of the electric motor 106 is 5 BHP at 50 percent of full load. In one embodiment, the energy management module 130 may be configured to calculate the capacity of the supercapacitor power packs 110 when connected to the processor 102 over the network interface 118. For example, the energy management module 130 calculates that each of the 10 supercapacitors connected in series can store 20 Ah of the electric charge.

Further, the energy management module 130 may be configured to determine if the power capacity of the electric motor 106 is below the threshold limit, at step 408. In one embodiment, the energy management module 130 may check whether the electric motor 106 may have a capacity below the threshold limit. In one embodiment, the threshold limit may be 90 percent of the power capacity of the electric motor 106. In one case, the energy management module 130 determines when the power capacity of the electric motor 106 is equal to or above the threshold limit of 90 percent, then the energy management module 130 may proceed further to step 410, to send energy data related to the electric motor 106 to the base module 128. For example, the energy management module 130 determines that when the power capacity of the electric motor 106 is equal to or above the threshold limit of 90 percent which is 10 BHP, does not need to be charged. In another case, the energy management module 130 determines that when the power capacity of the electric motor 106 is below the threshold limit of 90 percent, then the energy management module 130 may proceed to step 412, to measure the percentage of supercapacitor power packs 110 to be charged to deliver the threshold limit of power capacity to the electric motor 106. For example, the energy management module 130 determines that the power capacity of the electric motor 106 is 5 BHP, which is less than 5 BHP from the threshold power capacity of 90 percent. Further, the energy management module 130 may be configured to measure the percentage of supercapacitor power packs 110 to be charged to deliver threshold power capacity to the electric motor 106, at step 412. For example, the energy management module 130 measures that, out of the ten supercapacitor units, five supercapacitor units which are charged up to 60 percent of the capacity needs to be charged to deliver the power capacity of 10 BHP to the electric motor 106.

Successively, the energy management module 130 may be configured to send energy data related to the supercapacitor power packs 110 to the base module 128, at step 414. For example, the energy management module 130 sends to the base module 128 that, out of 10 supercapacitor units, five supercapacitor units which are charged up to 60 percent of the capacity needs to be charged to deliver the power capacity of 10 BHP to the electric motor 106.

Further, the base module 128 may be configured to receive energy data related to the supercapacitor power packs 110, at step 306. In one embodiment, the base module 128 may receive information related to the power capacity of the electric motor 106 and the percentage of full load. For example, the base module 128 receives information that, out of 10 supercapacitor units, five supercapacitor units which are charged up to 60 percent of the capacity needs to be charged to deliver the power capacity of 10 BHP to the electric motor 106. Successively, the base module 128 may be configured to trigger the AI/ML module 132, at step 308. Further, the AI/ML module 132 is described in FIG. 5.

FIG. 5 illustrates a flowchart of a method 500 performed by the AI/ML module 132. It should also be noted that in some alternative implementations, the functions noted in the blocks may occur out of the order noted in the drawings. For example, two blocks shown in succession in FIG. 5 may in fact be executed substantially concurrently or the blocks may sometimes be executed in the reverse order, depending upon the functionality involved. In addition, the process descriptions or blocks in flow charts should be understood as representing decisions made by a hardware structure such as a state machine.

At first, the AI/ML module 132 may be configured to receive a prompt from the base module 128, at step 502. The AI/ML module 132 may be configured to charge each of the supercapacitor power packs 110 up to the threshold limit. In one embodiment, the supercapacitor power packs 110 may be supercapacitor units and the threshold limit of each supercapacitor unit may be 90 percent of its capacity. In one embodiment, the AI/ML module 132 may be activated and deactivated automatically by the base module 128 upon receiving information related to the percentage of full load through the energy management module 130. Further, the AI/ML module 132 may be configured to retrieve information related to the percentage of full load from the charge management database 126, at step 504. In one embodiment, the AI/ML module 132 may be configured to retrieve information related to the percentage of the full load of the supercapacitor power packs 110 to be used or consumed by the electric motor 106, from the charge management database 126. For example, the AI/ML module 132 retrieves the charging requirement that 10 supercapacitor units connected in series need to be charged up to the threshold limit of 90 percent of their capacity.

Further, the AI/ML module 132 may be configured to measure the power capacity of the electric motor 106 with respect to the data retrieved from the charge management database 126 in real-time, at step 506. In one embodiment, the AI/ML module 132 may measure the amount of charge left within the electric motor 106 when connected with the supercapacitor power packs 110. In one embodiment, the AI/ML module 132 measures the amount of charge left on each of the supercapacitor power pack 110. For example, the AI/ML module 132 measures the amount of the electric charge of the electric motor 106 when connected to the supercapacitor power packs 110, for instance, the electric charge on the electric motor 106 is 80 coulombs corresponding to which the power capacity measured is 10 BHP.

Successively, the AI/ML module 132 may determine if charging of each of the supercapacitor power packs 110 is required, at step 508. In one case, the AI/ML module may determine that no charging of each of the supercapacitor power packs 110 is required, then the AI/ML module 132 is redirected back to step 506 to measure the power capacity of the electric motor 106 with respect to the data retrieved from the charge management database 126 in real-time. For example, the AI/ML module 132 determines that the 10 supercapacitors connected to the electric motor 106 are charged above 90 percent of their capacity to deliver the power capacity of 10 BHP to the electric motor 106. In another case, the AI/ML module 132 may determine that charging of the supercapacitor power packs 110 is required, then the AI/ML module 132 may enable the energy management module 130 to transfer the energy from the electric motor 106 to each supercapacitor power pack 110 up to the threshold limit at step 510. For example, the AI/ML module 132 determine that if out of 10 supercapacitor units, 3 supercapacitor units are completely drained to zero percent of their capacity, then the AI/ML module 132 proceeds to transfer energy from the electric motor 106 to each supercapacitor power pack 110 up to the threshold limit, at step 510. In one embodiment, the threshold limit of the supercapacitor power packs 110 may vary according to the desired usage of the supercapacitor power packs 110. In one exemplary embodiment, the threshold limit of each of 10 supercapacitor units may be up to 90 percent of their capacity to hold the electric charge of 25 Ah or 20 Ah for series or parallel connection. For example, the AI/ML module 132 charges the 3 supercapacitor, units which are at zero percent of their capacity to 90 percent of their capacity by transferring energy to the 3 supercapacitor units from the electric motor 106 having a power capacity of 10 BHP.

Successively, the AI/ML module 132 may be configured to send a first charging notification to the base module 128, at step 512. For example, the AI/ML module 132 sends the first charging notification that, out of the 10 supercapacitor units 3 have been charged to the threshold limit of 90 percent, four supercapacitor units are charged to 90 percent from 60 percent and the rest of 3 supercapacitor units are not charged. Further, the base module 128 may be configured to receive the first charging notification regarding data related to the power capacity of the electric motor 106 corresponding to the percentage of the full load from the AI/ML module 132 in real-time, at step 310. For example, the base module 128 receives the first charging notification that at the full load of 80 percent, the power capacity of the electric motor 106 is 6 BHP.

Successively, the base module 128 may be configured to trigger the charge detection module 134, at step 312. In one embodiment, the base module 128 may trigger the charge detection module 134 to determine whether there may be the supercapacitor power packs 110 to charge and/or discharge. The charge detection module 134 is described in FIG. 6.

FIG. 6 illustrates a flowchart of a method 600 performed by the charge detection module 134. It should also be noted that in some alternative implementations, the functions noted in the blocks may occur out of the order noted in the drawings. For example, two blocks shown in succession in FIG. 6 may in fact be executed substantially concurrently or the blocks may sometimes be executed in the reverse order, depending upon the functionality involved. In addition, the process descriptions or blocks in flow charts should be understood as representing decisions made by a hardware structure such as a state machine.

At first, the charge detection module 134 may be configured to receive a prompt from the base module 128, at step 602. The charge detection module 134 may be configured to charge the supercapacitor power packs 110 up to the threshold limit. In one embodiment, the supercapacitor power packs 110 may be supercapacitor batteries and the threshold limit of each supercapacitor battery may be 90 percent of its capacity. In one embodiment, the charge detection module 134 may be activated and deactivated automatically by the base module 128 upon receiving the request from the energy management module 130 related to the charging requirement of the supercapacitor power packs 110 based on the percentage of the full load obtained through the charge management database 126. Further, the charge detection module 134 may be configured to retrieve data related to the percentage of the full load from the charge management database 126, at step 604. In one embodiment, the charge detection module 134 may be configured to retrieve charging requirement of the supercapacitor power packs 110 to be used or consumed by the electric vehicle, such as golf cart, baby cart, electric car, etc., from the charge management database 126. For example, the charge detection module 134 retrieves the charging requirements that fifteen supercapacitor batteries connected in series need to be charged equal to more than 90 percent of their capacity.

Further, the charge detection module 134 may be configured to measure the amount of electric charge of each of the supercapacitor power pack 110 with respect to data retrieved from the charge management database 126 in real-time, at step 606. In one embodiment, the charge detection module 134 may also measure the amount of charge left in each of the supercapacitor power packs 110 when connected to the electric motor 106. In one embodiment, the charge detection module 134, measures the amount of charge left on each of the supercapacitor power packs 110. For example, the charge detection module 134, measures that the 15 supercapacitor batteries, when connected to the integrated power system 100, for instance, five supercapacitor batteries are fully drained, four supercapacitor batteries are still charged up to 60 percent and six supercapacitor batteries are charged more than 90 percent of their capacity. Successively, the charge detection module 134 may determine if charging of each of the supercapacitor power pack 110 is required, at step 608.

The charge detection module 134 may use many methods, algorithms or rules to determine if the supercapacitor power packs 110 need charging, such as, but not limited to (1) charging only one sub unit supercapacitor, (2) charging multiple sub units supercapacitors, (3) charging an group of sub units or entire units, (4) charging a particular location of supercapacitor (e.g. internal to the motor), (5) charging a supercapacitor that has a more complex shape over a simple shape, (6) charging supercapacitor power packs 110 due to historical data, (7) charging supercapacitor power packs 110 due to predictions of motor use, (8) charging supercapacitor power packs 110 due to machine learning of past data, (9) charging supercapacitor power packs 110 due to outside temperature, (10) charging supercapacitor power packs 110 due to geolocation of vehicle (terrain changes along an actual or predicted route), (11) charging supercapacitor power packs 110 due to AI correlation of historical data, (12) charging supercapacitor power packs 110 due to unsupervised real time machine learning of charging vs. motor use, etc.

In one case, the charge detection module 134 may determine that no charging of each of the supercapacitor power packs 110 is required, then the charge detection module 134 is redirected back to step 606 to measure the amount of electric charge of each supercapacitor power pack 110. For example, the charge detection module 134 determines, that each of fifteen supercapacitor batteries is charged above the threshold limit of 90 percent. In another case, the charge detection module 134 may determine that charging of the supercapacitor power packs 110 is required, then the charge detection module 134 may move to step 610. In one embodiment, energy is transferred to each supercapacitor power pack 110 up to the threshold limit utilizing the power capacity of the electric motor 106. For example, the charge detection module 134 determines that if each of the fifteen supercapacitor units is completely drained to zero percent of their capacity, then the charge detection module 134 may proceed to transfer energy to each supercapacitor power pack up to the threshold limit through the energy management module 130, by charging the supercapacitor power packs 110 to value of 50 coulombs. In one embodiment, the threshold limit of the supercapacitor power packs 110 may vary according to the desired usage of the supercapacitor power packs 110. In one exemplary embodiment, the threshold limit of each of the 15 supercapacitor batteries may be up to 90 percent of their capacity to hold the electric charge. For example, the charge detection module 134 charges the five supercapacitor batteries which are at zero percent of their capacity to 90 percent of their capacity for the electric vehicle to complete one run time along a road of one kilometer.

Successively, the charge detection module 134 may be configured to send a second charging notification to the base module 128, at step 612. For example, the charge detection module 134 is configured to send the second charging notification that, out of fifteen supercapacitor batteries, five have been charged to the threshold limit of 90 percent, four supercapacitor batteries are charged to 90 percent from 60 percent and the rest of six supercapacitor batteries are not charged. Further, the base module 128 may be configured to receive the second charging notification from the charge detection module 134 regarding information related to charging supercapacitor power packs 110, at step 314. For example, the base module 128 receives the second charging notification that, out of fifteen supercapacitor batteries, five have been charged to the threshold limit of 90 percent from initially with zero percent of the electric charge, four supercapacitor batteries are charged to 90 percent from 60 percent and the rest of six supercapacitor batteries are not charged.

Successively, the base module 128 may be configured to trigger the motor control module 136, at step 316. In one embodiment, the base module 128 may trigger the motor control module 136 to determine data related to the speed of the electric motor 106 and receive information related to the charging of the supercapacitor power packs 110. The motor control module 136 is described in FIG. 7.

FIG. 7 illustrates a flowchart of a method 700 performed by the motor control module 136. It should also be noted that in some alternative implementations, the functions noted in the blocks may occur out of the order noted in the drawings. For example, two blocks shown in succession in FIG. 7 may in fact be executed substantially concurrently or the blocks may sometimes be executed in the reverse order, depending upon the functionality involved. In addition, the process descriptions or blocks in flow charts should be understood as representing decisions made by a hardware structure such as a state machine.

At first, the motor control module 136 may be configured to receive a prompt from the base module 128, at step 702. The motor control module 136 may be configured to charge the supercapacitor power packs 110, 112 up to the threshold limit. In one embodiment, the energy sources of the ESU 107 may include supercapacitor power packs 110, 112 and/or a battery pack 116 that may include supercapacitor batteries and the threshold limit of each battery may be 90 percent of its capacity. The motor control module 136 may be configured to retrieve information related to the power capacity of the electric motor 106 corresponding to the percentage of the full load, at step 704. In one embodiment, the motor control module 136 may be activated and deactivated automatically by the base module 128 upon receiving the request from the energy management module 130 related to the power capacity of the electric motor 106 corresponding to the percentage of the full load from the charge management database 126. In one embodiment, the motor control module 136 may be configured to retrieve the charging requirement of the supercapacitor power packs 110 to be used or consumed by the electric vehicle, such as electric car, etc., from the charge management database 126. For example, the motor control module 136 retrieves the charging requirements that ten supercapacitor batteries connected in series need to be charged equal to more than 90 percent of their capacity.

Further, the motor control module 136 may be configured to measure data related to the speed of the electric motor 106 in real-time, at step 706. In one embodiment, the motor control module 136 may measure the amount of charge left in each of the supercapacitor power packs 110 when connected with the processor 102. In another embodiment, the motor control module 136, measures the change in speed of the electric motor 106 corresponding to a change in the percentage of the full load. For example, the motor control module 136 measures that the speed of the electric motor 106 is 120 RPM corresponding to the power capacity of the electric motor 106 having 6 BHP at 100 percent of full load. Successively, the motor control module 136 may determine if charging of each of the supercapacitor power packs 110 is required based on the speed of the electric motor 106, at step 708. For example, the motor control module 136 determines, that four supercapacitor batteries need to be recharged from zero percent of their capacity, and the rest of the two supercapacitor batteries are charged above the threshold limit of 90 percent utilizing the power capacity of the electric motor 106 with 6 BHP at a certain range of the percentage of the full load.

In one case, the motor control module 136 may determine that no charging of each of the supercapacitor power packs 110 is required, then the motor control module 136 is redirected back to step 706 to measure the data related to the speed of the electric vehicle. For example, the motor control module 136 determines that if each of the ten supercapacitor batteries is charged equal to or more than 90 percent of their capacity. In another case, the motor control module 136 may determine that charging of the supercapacitor power packs 110 is required, then the motor control module 136 may move to step 710. For example, the motor control module 136 determines that if each of the ten supercapacitor batteries is completely drained to zero percent of their capacity, then the motor control module 136 may proceed to transfer energy to each power pack up to the threshold limit, at step 710. In one embodiment, the threshold limit of the supercapacitor power packs 110 may vary according to the desired usage of the supercapacitor power packs 110. In one exemplary embodiment, the threshold limit of each of ten supercapacitors is up to 90 percent of their capacity to hold the electric charge. For example, the motor control module 136 charges the four supercapacitor batteries which are at zero percent of their capacity to 90 percent of their capacity for the electric vehicle to complete one run time along a road of one kilometer.

Successively, the motor control module 136 may be configured to send a third charging notification to the base module 128, at step 712. For example, the motor control module 136 is configured to send the third charging notification that, out of ten lead-acid batteries, four have been charged to the threshold limit of 90 percent, four lead-acid batteries are charged to 90 percent from 60 percent and the rest of two lead-acid batteries are not charged. Further, the base module 128 may be configured to receive the third charging notification from the motor control module 136, at step 318 regarding data related to the speed of the electric motor 106. For example, the base module 128 receives the third charging notification that, out of ten lead-acid batteries, four have been charged to the threshold limit of 90 percent from initially with zero percent of the electric charge, four lead-acid batteries are charged to 90 percent from 60 percent and the rest of two lead-acid batteries are not charged. The motor control module 136 is further configured to provide enablement of different operative mode controls of the electric motor 106 based on the speed of the electric motor 106 and the power capacity of the electric motor 106. The different operative mode controls are regenerative braking, dynamic braking, and plugging.

Further, the base module 128 may be configured to trigger supercapacitor module 138, at step 320. In one embodiment, the supercapacitor module 138 may be configured to identify problems during charging of the supercapacitor power packs 110. The supercapacitor module 138 is described in conjunction with FIG. 8.

FIG. 8 illustrates a flowchart of a method 800 performed by the supercapacitor module 138. It should also be noted that, in some alternative implementations, the functions noted in the blocks may occur out of the order noted in the drawings. For example, two blocks shown in succession in FIG. 8 may in fact be executed substantially concurrently or the blocks may sometimes be executed in the reverse order, depending upon the functionality involved. In addition, the process descriptions or blocks in flow charts should be understood as representing decisions made by a hardware structure such as a state machine.

At first, the supercapacitor module 138 may be configured to receive a prompt from the base module 128, at step 802. The supercapacitor module 138 may be configured to determine the amount of charge required from each of the supercapacitor power packs 110. Further, the supercapacitor power packs 110 may be configured to retrieve information related to the speed of the electric motor 106 from the charge management database 126, at step 804. In one embodiment, the supercapacitor module 138 may be configured to retrieve information related to measuring data related to the charge corresponding to the speed of the electric motor 106 from the charge management database 126. For example, the supercapacitor module 138 retrieves information that the speed of the electric motor 106 is 120 RPM corresponding to 100 percent of the full load at an electric motor power capacity of ten BHP. Further, the supercapacitor module 138 may be configured to measure data related to the charge stored in the supercapacitor power packs 110 based on the speed of the electric motor 106, at step 806. For example, the supercapacitor module 138 determines that, out of ten lead-acid batteries, only six lead-acid batteries are charged up to 90 percent of their capacity corresponding to the speed of 120 RPM of the electric motor 106 having the power capacity of ten BHP.

Successively, the supercapacitor module 138 may determine, if the supercapacitor power packs 110 are properly charged above the threshold limit, at step 808. In one embodiment, the supercapacitor module 138 may be configured to determine whether each of the plurality of supercapacitor power packs 110 may be charged above the threshold limit. In one case, the supercapacitor module 138 may determine if the supercapacitor power packs 110 are charged below the threshold limit, then the supercapacitor module 138 may proceed to step 810 to measure the amount of the electric charge required from each of the supercapacitor power packs 110. For example, the supercapacitor module 138 determines that if the required electric charge from the ten lead-acid batteries is 90 C and, out of the ten lead-acid batteries, four are charged above the threshold limit of 90 percent to deliver the charge of 90 C for each lead-acid battery and the remaining four which are charge below 60 percent of their capacity deliver the charge of 40 C. Therefore, the supercapacitor module 138 measures that the ten lead-acid batteries with the current state of charge profile can deliver 80 C of charge for charging the supercapacitor power packs 110 and the supercapacitor module 138 may then proceed to step 812, to send the information related to the energy requirements of the supercapacitor power packs 110 to the base module 128.

In another case, the supercapacitor module 138 may determine that if each of the supercapacitor power packs 110, 112 are charged above the threshold limit, then the supercapacitor module 138 may proceed to step 812 to send information related to the energy and charging requirements of the supercapacitor power packs 110, 112 to the base module 128. For example, the supercapacitor module 138 determines that, out of ten lead-acid batteries, each of the ten lead-acid batteries are charged above the threshold limit of 90 percent to maintain the state of charge profile by delivering the continuous charge cycle for 20 hours from the ten lead-acid batteries. Further, the supercapacitor module 138 may be configured to send the information related to the energy and the charging requirements of the supercapacitor power packs 110, 112 to the base module 128, at step 812. For example, the supercapacitor module 138 is configured to send to the base module 128 that, out often lead-acid batteries, four batteries need to be charged to achieve an overall charge cycle of twenty hours from the lead-acid batteries. Successively, the base module 128 may be configured to receive information related to the charging of the supercapacitor power packs 110, at step 322. For example, the base module 128 receives information that, out of ten lead-acid batteries, four batteries need to be charged to achieve an overall charge cycle of twenty hours from the lead-acid batteries. The base module 128 may be configured to trigger the communication module 140, at step 324. The communication module 140 is described in FIG. 9.

FIG. 9 illustrates a flowchart of a method 900 performed by the communication module 140. It should also be noted that in some alternative implementations, the functions noted in the blocks may occur out of the order noted in the drawings. For example, two blocks shown in succession in FIG. 9 may in fact be executed substantially concurrently or the blocks may sometimes be executed in the reverse order, depending upon the functionality involved. In addition, the process descriptions or blocks in flow charts should be understood as representing decisions made by a hardware structure.

At first, the communication module 140 may be configured to receive a prompt from the base module 128, at step 902. The communication module 140 may be configured to charge the supercapacitor power packs 110, 112 to meet the desired charge cycle. In one embodiment, the desired charge cycle of each of the supercapacitor power packs 110 may be two hours when each supercapacitor power pack 110, 112 is charged up to the threshold limit of 90 percent. In one embodiment, the communication module 140 may be configured to be activated and/or deactivated by the base module 128 according to the information received from the supercapacitor module 138 to charge and/or discharge the supercapacitor power packs 110, 112 respectively. Successively, the communication module 140 may be configured to retrieve information related to the charge stored in the supercapacitor power packs 110, 112 from the charge management database 126, at step 904. In one embodiment, the communication module 140 may retrieve information that each of the supercapacitor power packs 110, 112 are charged below the threshold limit. For example, the communication module 140 retrieves information that the ten supercapacitor batteries are charged nearly 80 percent of their capacity, which is below the threshold limit of 90 percent to deliver the desired charge cycle of 20 hours.

Further, the communication module 140 may be configured to measure the amount of flow of energy from the supercapacitor power packs 110, 112 integrated with the electric motor 106 to the battery pack 116 of the electric vehicle in real-time, at step 906. In one embodiment, the communication module 140 may be configured to measure the charge stored in each of the supercapacitor power packs 110, 112, which may be previously charged by their respective modules. For example, communication module 140 measures and communicates that, out of the ten supercapacitor units, five are charged 70 percent of their capacity, four are charged 75 percent of their capacity, and one is charged above the threshold limit of 90 percent, by the supercapacitor module 138, and out of the fifteen supercapacitor batteries, five are charged 90 percent of their capacity, six are charged around 60 percent of their capacity and four are charged 70 percent of their capacity, and similarly, out of the ten lead-acid batteries six are charged 90 percent of their capacity, and four are charged near 60 percent of their capacity, by the supercapacitor module 138.

Further, the communication module 140 may determine if each supercapacitor power pack 110 or 112 is charged enough to deliver the charge cycle, at step 908. In one embodiment, the communication module 140 may determine whether each of the power packs 110, 112 are charged enough for consumption or to be used during the specified or desired charge cycle. In one case, the communication module 140 may determine that if the supercapacitor power packs 110, 112 are not charged equal to or above the threshold limit to deliver the desired charge cycle from each power pack. For example, the communication module 140 determines that, if the desired charge cycle from the ten lead-acid batteries is 20 hours and out of the ten lead-acid batteries, six are charged 90 percent of their capacity, and four are charged near 60 percent of their capacity, and the overall charge cycle of the ten lead-acid batteries is 16 hours, which is four hours less than the desired charge cycle. In this case, the communication module 140 may proceed to step 910 to transfer energy to the supercapacitor power packs 110, 112 to meet the desired charge cycle. In another case, the communication module 140 may determine that if the plurality of supercapacitor power packs 110, 112 are charged equal to above the threshold limit to deliver the desired charge cycle. For example, the communication module 140 determines that if the desired charge cycle from the ten lead-acid batteries is 20 hours, and each of the ten lead-acid batteries is charged above the threshold limit of 90 percent to deliver the charge cycle of 20 hours (two hours from each lead-acid battery). In this case, the communication module 140 may proceed to step 912 to send the information related to energy transfer to the supercapacitor power packs 110 to the base module 128.

Successively, the communication module 140 may be configured to transfer energy to the supercapacitor power packs 110, 112 to meet the desired charge cycle, at step 910. For example, the communication module 140 communicates that the ten lead-acid batteries if the desired charge cycle from the ten lead-acid batteries is 20 hours, and out of the ten lead-acid batteries, six are charged 90 percent of their capacity, and four are charged near 60 percent of their capacity, and the overall charge cycle of the ten lead-acid batteries is 16 hours, which is four hours less than the desired charge cycle, then the communication module 140 charges the rest of four lead-acid batteries up to the threshold limit of 90 percent to meet the desired charge cycle of two hours from each of the ten lead-acid batteries. Further, the communication module 140 may be configured to send the information related to the transfer of energy to the supercapacitor power packs 110 to the base module 128, at step 912. For example, the communication module 140 is configured to send to the base module 128 that each of the ten lead-acid batteries is charged above the threshold limit of 90 percent to deliver the desired charging cycle of 20 hours. Successively, the base module 128 receives the information related to the transfer of energy to the supercapacitor power packs 110, 112 at step 326. For example, the base module 128 receives information that ten lead-acid batteries are charged above the threshold limit of 90 percent to deliver the desired charging cycle of 20 hours. Further, the base module 128 may be configured to send the information related to the transfer of energy to the supercapacitor power packs 110 to the display interface 104, at step 328. For example, the base module 128 sends information that the ten lead-acid batteries are charged above the threshold limit of 90 percent to deliver the desired charging cycle of 20 hours.

The integrated power system 100 may have many advantages, such as but not limited to, the efficiency of the electric motor 106 coupled with graphene supercapacitors to generate electric charge from the electric motor 106 and store the electric charge in the supercapacitor power packs 110. In another embodiment, the supercapacitor power packs 110, 112 may provide the regenerative mechanism to store the electric charge received from the electric motor 106 and supply the electric charge to the battery pack 116. In one embodiment, the electric motor 106 integrated with the supercapacitor power packs 110, 112 may provide minimal noise while the electric vehicle is accelerating and/or decelerating. In one embodiment, a rotor may be used in place of the electric motor 106 to power the electric vehicle engine. In one embodiment, the supercapacitor power packs 110, 112 may be layered around the outer circumference of the cylindrical structure of the electric motor 106. In another embodiment, the supercapacitor power packs 110, 112 may be layered in flexible pouches. It can be noted that the pouches may be flexible and can be layered on an outer circumference of the supercapacitor power packs 110, 112. The electric motor 106 integrated with the supercapacitor power packs 110, 112 may generate enormous power with less noise. In one embodiment, the integrated power system 100 may generate high current at low revolutions of the electric motor 106, and recovery of the energy is highly efficient due to the reduction of unrealized power transfer.

All patents and patent applications cited are to be understood as being incorporated by reference to the degree they are compatible herewith.

For all ranges given herein, it should be understood that any lower limit may be combined with any upper limit, when feasible. Thus, for example, citing a temperature range of from 5° C. to 150° C. and from 20° C. to 200° C. would also inherently include a range of from 5° C. to 200° C. and a range of 20° C. to 150° C.

When listing various aspects of the products, methods, or system described herein, it should be understood that any feature, element or limitation of one aspect, example, or claim may be combined with any other feature, element or limitation of any other aspect when feasible (i.e., not contradictory). Thus, disclosing an example of power pack comprising a temperature sensor and then a separate example of a power pack associated with an accelerometer would inherently disclose a power pack comprising or associated with an accelerometer and a temperature sensor.

Unless otherwise indicated, components such as software modules or other modules may be combined into a single module or component, or divided such that the function involves cooperation of two or more components or modules. Identifying an operation or feature as a discrete single entity should be understood to include division or combination such that the effect of the identified component is still achieved.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

What is claimed is:

1. An integrated power system for energy management of an electric vehicle including an electric motor, comprising:
a plurality of supercapacitor power packs coupled together in series and/or in parallel and integrated with the electric motor;
a processor coupled to the plurality of supercapacitor power packs to perform charging and/or discharging of each of the plurality of supercapacitor power packs based, at least in part, on a power capacity of the plurality of supercapacitor power packs and at least one additional factor;
a base module communicatively coupled to the processor, wherein the base module comprises a plurality of sub-modules to perform charging and/or discharging of the plurality of supercapacitor power packs according to instructions received from the processor; and
a display interface coupled to the processor and configured to continuously display a status of charging and/or discharging of a battery pack of the electric vehicle based on charge on the plurality of supercapacitor power packs.

2. The integrated power system of claim 1, wherein the at least one additional factor comprises a speed of the electric motor.

3. The integrated power system of claim 1, wherein the at least one additional factor comprises a relative complexity of a shape of one or more supercapacitors.

4. The integrated power system of claim 1, wherein the at least one additional factor comprises historical data regarding operation of the electric motor.

5. The integrated power system of claim 4, wherein the historical data is correlated via machine learning.

6. The integrated power system of claim 1, wherein the at least one additional factor comprises a prediction of use of the electric motor.

7. The integrated power system of claim 6, wherein the prediction of use is provided by machine learning.

8. The integrated power system of claim 1, wherein the at least one additional factor comprises a temperature outside of the electric vehicle.

9. The integrated power system of claim 1, wherein the at least one additional factor comprises a geolocation of the electric vehicle.

10. The integrated power system of claim 9, wherein the geolocation of the electric vehicle indicates one or more terrain changes along an actual or predicted route.

11. The integrated power system of claim 1, wherein the at least one additional factor comprises real-time machine learning of historical charging verses electric motor use.

12. The integrated power system of claim 1, wherein at least one sub-module is configured to charge and/or discharge one or more of the plurality of supercapacitor power packs.

13. The integrated power system of claim 1, wherein at least one sub-module is configured to charge and/or discharge only one sub-unit of a supercapacitor.

14. The integrated power system of claim 1, wherein at least one sub-module is configured to charge and/or discharge multiple sub-units of one or more supercapacitors.

15. The integrated power system of claim 1, wherein at least one sub-module is configured to charge a group of sub-units of one or more supercapacitors.

16. The integrated power system of claim 1, wherein at least one sub-module is configured to charge one or more supercapacitors based on their location relative to the electric motor.

17. The integrated power system of claim 1 further comprising thermal control hardware in association with the plurality of supercapacitor power packs to regulate supercapacitor temperature.

18. The integrated power system of claim 17, wherein the thermal control hardware comprises systems for both cooling and heating of supercapacitors.

19. The integrated power system of claim 17, wherein the thermal control hardware comprises a low-temperature power source for warming one or more supercapacitors to a suitable operating temperature.

20. The integrated power system of claim 17, wherein the base module further comprises a thermal management module operably associated with the thermal control hardware to control the temperature of supercapacitors during at least one of starting and operating the electric vehicle.
